(19) United States
(12) Patent Application Publication
(10) Pub. No.: US 2026/0288798 A1
(43) Pub. Date: Sep. 24, 2026

(54) SYSTEM

(71) Applicant: SoftBank Group Corp., Tokyo (JP)

(72) Inventor: Yumiko WATANABE, Tokyo (JP)

(73) Assignee: SoftBank Group Corp., Tokyo (JP)

(21) Appl. No.: 19/560,138

(22) Filed: Mar. 9, 2026

(30) Foreign Application Priority Data
Mar. 19, 2025 (JP) 2025-044533

(51) Int. Cl. G06F 16/3329; G06F 40/30; G10L 15/22; G10L 15/26

(52) U.S. Cl. CPC G06F 16/33295; G06F 40/30; G10L 15/22; G10L 15/26

(57) ABSTRACT

A system includes a processor that is configured to provide an interface for receiving input information from a user, analyze a communication application identifier or an information retrieval tool identifier of the user to complement necessary information, and generate a prompt sentence for a generative AI model and input the prompt sentence into the generative AI model.

### CROSS-REFERENCE TO RELATED APPLICATION

This application is based on and claims priority under 35 USC 119 from Japanese Patent Application No. 2025-044533 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional procedures for preparing documents and performing data entry based on user requests, such as address change notifications or other administrative updates, require users to manually understand and comply with complex forms, specific document formats, and varied input requirements imposed by different service providers or institutions. Users often communicate their intentions through general-purpose communication applications or information retrieval tools, but existing systems do not effectively utilize identifiers or contextual information from these tools to automatically infer missing details or to generate appropriate instructions for downstream processing. As a result, users must repeatedly input similar information, face a high risk of input errors or omissions, and often require human operator assistance. Furthermore, when identity verification is necessary, conventional systems typically handle authentication separately from document creation and data entry, leading to fragmented workflows and inefficient processing. Accordingly, there is a need for a system that can receive user input in a flexible manner, automatically complement necessary information using application or tool identifiers, generate appropriate prompts to a generative AI model for document or data preparation, and, when required, integrate identity verification into a unified processing flow.

### SUMMARY

In order to solve the above-described problems, a system according to one aspect of the present invention comprises a processor, wherein the processor is configured to provide an interface for receiving input information from a user, analyze a communication application identifier or an information retrieval tool identifier of the user to complement necessary information, and generate a prompt sentence for a generative AI model and input the prompt sentence into the generative AI model. In one embodiment, the processor is configured, when the input information from the user relates to address change, to input into the generative AI model a prompt sentence generated on the basis of the input information, so that the generative AI model can automatically produce content such as completed forms, draft documents, or structured data reflecting the address change. In another embodiment, the processor is configured to verify an identity of the user by using a public authentication system and to start processing for document creation or data entry on the basis of an authentication result, thereby ensuring that only authenticated requests lead to formal document generation or database updates. By combining interface provision, identifier-based information completion, prompt generation for a generative AI model, and integrated identity verification, the system enables streamlined, automated, and reliable handling of user requests that would otherwise require manual interpretation and processing.

The term “system” refers to an arrangement of one or more hardware and software components that cooperate to perform the functions described in the present specification and claims.

The term “processor” refers to one or more hardware processing units, such as a central processing unit (CPU), a microprocessor, a microcontroller, a digital signal processor (DSP), or any combination thereof, configured to execute instructions to perform the functions described in the present specification and claims.

The term “interface” refers to a hardware and/or software component that enables exchange of information between the system and a user or another system, including but not limited to graphical user interfaces, application programming interfaces (APIs), command-line interfaces, and messaging interfaces.

The term “input information” refers to any data, instruction, request, or content provided by a user to the system through the interface, including but not limited to text, selectable options, form entries, and voice input converted to text.

The term “user” refers to any human individual or entity that operates a client device or application to provide input information to the system and to receive output from the system.

The term “communication application identifier” refers to information that identifies a communication application used by the user, such as an application name, application ID, account ID, session ID, or any associated metadata that indicates the type or instance of the communication application.

The term “information retrieval tool identifier” refers to information that identifies an information retrieval tool used by the user, such as a web browser, search engine, or specialized query interface, including any corresponding tool name, tool ID, account ID, or metadata that characterizes the tool.

The term “complement necessary information” refers to a process in which the processor infers, acquires, or fills in missing or incomplete data required for subsequent processing, based on the communication application identifier, the information retrieval tool identifier, or other contextual information.

The term “generative AI model” refers to a machine learning model, such as a neural network-based language model, that is trained to generate natural language text or other content in response to input data or prompts.

The term “prompt sentence” refers to a piece of text or a structured textual instruction generated by the processor for input to the generative AI model, the text or instruction being designed to cause the generative AI model to produce a desired output.

The term “address change” refers to a modification of address-related information of the user, including but not limited to a residential address, mailing address, or registered address, that is to be reflected in documents, records, or databases.

The term “public authentication system” refers to an authentication mechanism provided or recognized by a public authority, government agency, or trusted public service, which is capable of verifying the identity of a user, for example through electronic certificates, ID cards, or online identity services.

The term “verify an identity of the user” refers to a process in which the processor confirms that the person or entity providing the input information is the legitimate user, by using the public authentication system or equivalent verification mechanisms.

The term “document creation” refers to generating, populating, or completing one or more documents, such as forms, applications, notifications, or letters, based on the input information from the user and optionally on the output from the generative AI model.

The term “data entry” refers to the process of inputting, updating, or modifying structured data in a database, information system, or electronic record, based on the input information from the user and optionally on the output from the generative AI model.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

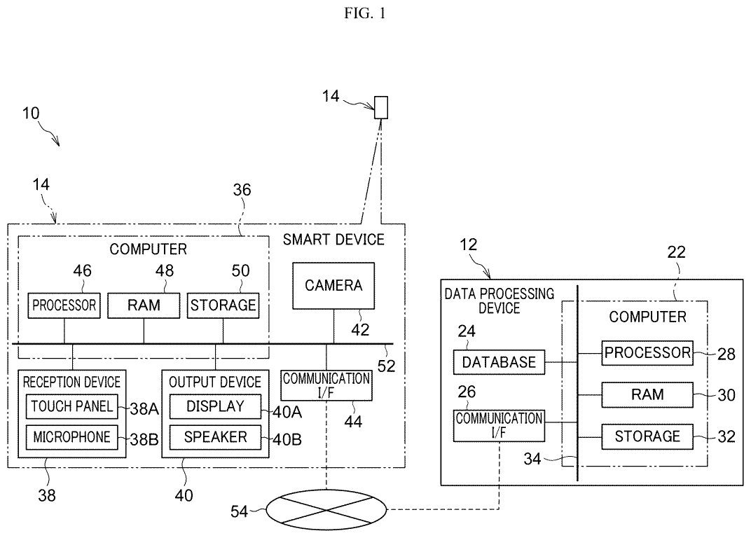

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

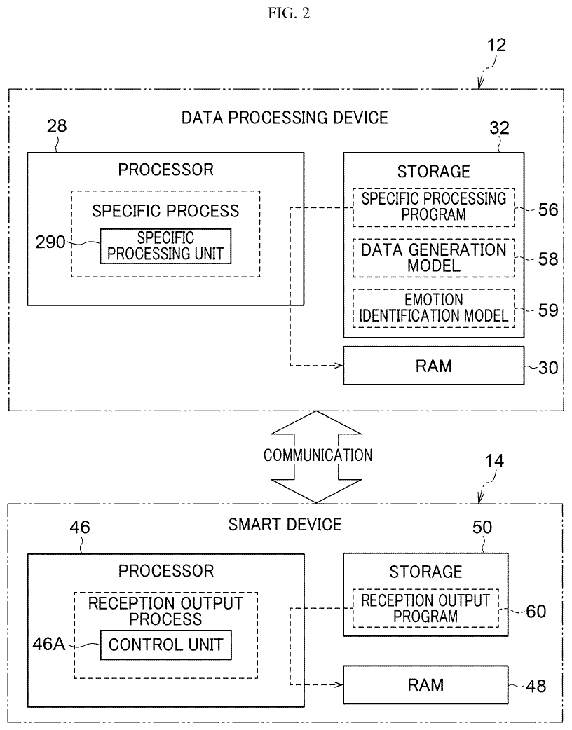

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented systems for monitoring the emotional condition of individuals, such as learners or minors, primarily rely on simple keyword matching or coarse sentiment scoring applied to text data. These systems typically process user utterances or messages with rule-based filters or basic sentiment classifiers that output a single positive/negative score, without leveraging deeper contextual inference. As a result, such systems often fail to capture nuanced emotional states, underlying latent problems, or risk trends over time.

Furthermore, known systems generally treat speech recognition, natural language processing, and generative model usage as isolated components. Audio capture may be handled by a front-end, sentiment analysis by a separate service, and any guidance to human operators may be produced manually or by static templates. This fragmented architecture leads to inefficient data flows, duplicated computation, and inconsistent or non-repeatable inferences. For example, an utterance may be transcribed and scored for sentiment, but the derived features are not systematically embedded into a machine-readable prompt for a higher-level inference engine. Consequently, the system cannot consistently generate structured, actionable outputs tailored to each subject.

Additionally, existing user interfaces for educators or supporters often present only raw transcripts or simple sentiment indicators, without computational aggregation across multiple time points and without automated prioritization. Human operators must manually scan large volumes of individual utterances to identify high-risk subjects. This creates cognitive overload and delays timely intervention, especially in environments where many subjects must be monitored concurrently.

From a computer technology perspective, there is a need for an integrated, technical solution that (i) coordinates audio acquisition, speech recognition, and natural language feature extraction in a unified processing pipeline, (ii) programmatically constructs structured prompt sentences that combine text and extracted features as input to a generative AI model, (iii) generates machine-readable, structured inference results that capture emotional states and latent problems, and (iv) aggregates such results over time into risk-oriented index information that can be automatically prioritized and rendered on a display. Without such an integrated and automated architecture, computer systems cannot efficiently support real-time or near-real-time identification of subjects who are at elevated emotional risk.

Accordingly, there is a demand for a computer-implemented system and method that improve the functioning of the underlying computer technology by tightly coupling speech recognition, natural language processing, prompt construction, generative AI inference, and time-series aggregation in a single processing flow executed by a processor. Such a system should reduce processing redundancy, ensure consistent feature utilization across components, generate structured outputs suitable for automated analysis, and provide improved user interfaces that highlight priority subjects based on computed risk scores, thereby enhancing the technical capability of computers to support decision-making in monitoring emotional conditions and latent problems of subjects.

The specific processing by the specific processing unit 290 of the data processing device 12 in Example 1 is realized by the following means.

The present invention provides a server comprising a processor configured to acquire audio data of a subject, convert the audio data into character string data by speech recognition processing, execute natural language processing on the character string data to extract emotion information, intention information, and feature word information, construct a prompt sentence based on the character string data and the extracted information, input the prompt sentence into a generative information processing model to obtain response information including emotional state information and latent problem information of the subject, store the response information and the natural language processing result, aggregate the stored information in a time-series manner for each subject to generate index information including risk-oriented score information, and output the response information and the index information via a display interface in a prioritized manner according to the score information. This enables an integrated computer-implemented processing pipeline that systematically combines speech recognition, natural language feature extraction, structured prompt construction for a generative AI model, machine-readable inference of emotional states and latent problems, and time-series aggregation with automated prioritization, thereby improving the functioning of the computer system in detecting, organizing, and presenting emotionally relevant risk information for timely human intervention.

The term “processor” refers to a hardware computing unit or a combination of hardware computing units configured to execute instructions, perform data processing, and control operations of the system.

The term “input/output interface” refers to a hardware and/or software component that enables acquisition of data from external devices or users and output of data to external devices or users, including, for example, user interface components, communication interfaces, and application programming interfaces.

The term “input information” refers to data provided by a user through the input/output interface, including, for example, textual input, selection input, and control commands.

The term “audio information” refers to sound data representing utterances or other acoustic signals associated with a subject, including data captured by a microphone or equivalent sound-capturing device.

The term “subject” refers to an individual or entity whose utterances, behaviors, or conditions are to be monitored, analyzed, or evaluated by the system.

The term “terminal” refers to an electronic device, separate from the server, configured to capture audio information of a subject and to transmit corresponding audio data to the server via a communication network.

The term “audio data” refers to digitized sound information, including raw or encoded waveform data, representing audio information captured by a terminal or other recording apparatus.

The term “speech recognition processing” refers to a computational procedure that converts audio data into character string data by recognizing spoken words and phrases contained in the audio data.

The term “character string data” refers to textual data represented as a sequence of characters, generated as a transcription or other textual representation of the audio data.

The term “natural language processing” refers to a set of computational techniques for analyzing and processing character string data written in a natural language, including, for example, linguistic analysis, sentiment analysis, and extraction of semantic features.

The term “emotion information” refers to data representing an estimated emotional state associated with the content of the character string data, including, for example, types of emotions and corresponding intensity values.

The term “intention information” refers to data representing an estimated communicative intent or purpose associated with the content of the character string data, such as avoidance, seeking help, or expressing dissatisfaction.

The term “feature word information” refers to data representing words, phrases, or terms that are extracted from the character string data as being semantically or contextually significant for further analysis.

The term “prompt sentence” refers to a constructed textual or structured input sequence that includes at least part of the character string data and associated analysis results, and that is formatted to be provided as input to a generative information processing model.

The term “generative information processing model” refers to a computational model configured to generate output data, such as text or structured information, in response to input data, and that typically uses probabilistic or machine learning techniques to perform generative inference.

The term “response information” refers to data output by the generative information processing model in response to the prompt sentence, including results of inference or estimation performed by the model.

The term “emotional state information” refers to a portion of the response information that represents a determined or inferred emotional condition of the subject, including, for example, categories of emotional states and their associated strengths or attributes.

The term “latent problem information” refers to a portion of the response information that represents inferred underlying issues, concerns, or problems associated with the subject, which are not explicitly stated in the original utterance but are estimated based on the analysis.

The term “time-series manner” refers to an arrangement or aggregation of data according to chronological order, such that multiple pieces of information associated with a subject are organized along a time axis.

The term “index information” refers to aggregated or derived data calculated from stored analysis results and response information for each subject, including, for example, summary indicators, trend values, and risk-related metrics.

The term “risk-oriented score information” refers to numerical or categorical values included in the index information that quantitatively or qualitatively represent a degree of risk or concern associated with the emotional state or latent problems of a subject.

The term “display interface” refers to a hardware and/or software component configured to present information to a user visually or otherwise, including, for example, display screens, graphical user interfaces, and web-based dashboards.

The term “support policy information” refers to information related to decisions, plans, or strategies for providing assistance, intervention, or guidance to a subject, which may be determined or refined by a user based on the output of the system.

In one embodiment, a system includes a server, one or more terminals, and one or more user devices interconnected via a communication network. The server includes at least one processor, a memory, and a network interface. The terminals each include at least one processor, a microphone, a local memory, and a network interface. The user devices each include at least one processor, a display, an input unit, and a network interface.

The terminal acquires audio information of a subject by using the microphone and a system-level audio capture framework. For example, the terminal uses an audio capture framework such as AVFoundation in a mobile operating system, a media recording framework in another mobile operating system, or an audio API in a desktop operating system to sample an analog audio signal at a predetermined sampling rate, such as 16 kHz with 16-bit linear PCM. The terminal stores the sampled audio frames in a circular buffer in its local memory and encodes the buffered data into an audio file format such as WAV or FLAC. The terminal associates the audio file with metadata including a subject identifier, a timestamp, and a recording context identifier (for example, classroom, home, or consultation room). The terminal transmits the audio file and metadata to the server via a transport protocol such as HTTPS using a predefined application-level interface.

The server receives the audio data through the network interface and stores the raw audio data in a non-volatile storage device, such as a magnetic disk or flash storage managed by an object storage subsystem. The server registers a record in a relational data store, such as a structured database management system, including a reference to the storage location of the audio data, the subject identifier, the timestamp, and the recording context identifier. The server thereby creates a unified audio data structure that separates the audio payload from indexing metadata, which improves retrieval performance and reduces duplication.

The server converts the audio data into character string data by executing speech recognition processing. The server uses a speech recognition module that may be implemented as a remote speech recognition service or as a local speech-to-text engine. In one embodiment, the server sends the audio file to a network-based speech recognition service via an application programming interface, specifying language, sampling rate, and model configuration parameters. The speech recognition module applies an acoustic model and a language model, such as a deep neural network acoustic model combined with a statistical or neural language model, to map audio feature vectors (for example, Mel-frequency cepstral coefficients) to token sequences. The server receives a transcription result including a character string, confidence scores for segments, and timing information. The server normalizes the transcription by applying text normalization rules, such as lowercasing, punctuation restoration, and removal of non-speech tokens. The server stores the normalized character string data and associated confidence data in the relational data store in a transcript table linked to the audio data record.

The server performs natural language processing on the character string data to extract emotion information, intention information, and feature word information. The server uses an NLP module that may be provided by a network-based NLP service or implemented as a local set of models. The server sends the character string to the NLP module with instructions for operations including tokenization, part-of-speech tagging, dependency parsing, sentiment analysis, and key phrase extraction. In one embodiment, the NLP module uses a sequence labeling model, such as a bidirectional recurrent neural network or a transformer-based encoder, to identify tokens and assign part-of-speech tags and semantic labels. For sentiment and emotion analysis, the NLP module uses a classifier that maps sentence representations to emotion categories (for example, anxiety, sadness, anger, joy) and intensity scores. For intention information, the NLP module applies a multi-class classifier trained on labeled data representing communicative intents like avoidance, compliance, resistance, and help-seeking. For feature word information, the NLP module applies a key phrase extraction algorithm, such as attention-based scoring or statistical scoring (for example, TF-IDF) to identify words or phrases strongly associated with contexts like school, home, or peer relationships.

The server stores the NLP results in a structured format in the relational data store. The server maintains separate tables for emotion information, intention information, and feature word information, and relates each record to the corresponding transcript entry via a foreign key. The server also maintains a normalized representation of emotion and intention as vectors in an embedding space, computed by the NLP module, which allows subsequent similarity computations and aggregation. This structured storage and embedding representation enable efficient querying and aggregation of emotional and intentional patterns across many subjects and over long time spans.

The server constructs a prompt sentence to be input to a generative AI model. The server retrieves the character string data, the corresponding emotion information, intention information, and feature word information from the database. The server applies a template-based prompt construction module implemented in software running on the processor. The prompt construction module defines a layout that combines the original utterance, the NLP-derived features, and an explicit instruction to the generative AI model. In one concrete example, the server constructs a prompt sentence of the following form:
“You are an expert child psychologist.
Child's utterance: ‘I don't want to go to school tomorrow.’
NLP analysis: sentiment=−0.9 (strongly negative), emotions=[anxiety, sadness], key phrases=[school, tomorrow].
Based on this information, infer the child's emotional state and up to three possible underlying problems in daily life or the educational environment.
Output as emotional_state, possible_problems, and brief_support_suggestions.”

The server replaces the example utterance text, sentiment value, emotion labels, and key phrases with the actual values extracted by the NLP module. The server may further add contextual information, such as the number of similar utterances in the last week or known context tags (for example, “recent absence from school”), computed from the aggregation module described below. Unlike a simple concatenation of text, the server enforces a consistent structure and ordering of fields in the prompt sentence, which reduces ambiguity for the generative AI model and systematically encodes the output of the feature extraction stage. As a result, the generative AI model receives a richer and more regularized input representation than would be provided by raw text alone.

The server inputs the prompt sentence into a generative AI model that is implemented as a trained neural network. In one embodiment, the generative AI model is a transformer-based language model having multiple self-attention layers, feedforward layers, and layer normalization components. The model internally represents the prompt sentence as a sequence of token embeddings and applies positional encodings. The model has been trained, prior to deployment, on a corpus of conversation-like texts and psychological counseling-like texts, using a language modeling objective. Additionally, the model is fine-tuned on a domain-specific dataset where utterances, emotion labels, and latent problems are linked, using a supervised learning objective that minimizes a loss function combining cross-entropy loss on target tokens and metric-based loss on structured outputs. The weights of the neural network are updated during training by a gradient-based optimization algorithm such as Adam, and training employs regularization techniques such as dropout and gradient clipping to improve generalization.

In operation, the server sends the prompt sentence to the generative AI model via an API or via a direct function call if the model is hosted locally. The server specifies inference parameters including maximum output length, sampling temperature, and decoding strategy (for example, beam search or nucleus sampling). The generative AI model processes the tokenized prompt through its attention layers and generates continuation tokens representing the response information. The server receives the generated text and parses the response based on expected output fields, such as an emotional_state label, a list of possible_problems, and brief_support_suggestions. The server enforces constraints at the parsing stage, for example by detecting structured delimiters or keyword markers that are mandated in the prompt template, which reduces the risk of malformed output. The use of this structured prompt sentence and constrained parsing yields a consistent, machine-readable format from a generative model that would otherwise produce free-form text.

The server stores the response information in a relational structure linked to the transcript entry and the subject identifier. The server represents emotional_state as an enumerated type or as a vector in an emotion embedding space; the server represents each possible problem as a text description associated with a category label (for example, bullying risk, academic stress, family conflict). This structured design enables later aggregation and statistical analysis across many inferred outputs.

The server aggregates the stored information in a time-series manner for each subject and generates index information including risk-oriented score information. The server maintains a time-indexed sequence of records for each subject, where each record contains at least one sentiment value from the NLP module, one or more emotion labels, one or more inferred emotional_state values, and any latent problem categories from the generative AI model. The server applies an aggregation algorithm that computes, for example, an exponentially weighted moving average of negative sentiment scores, a count of occurrences of high-anxiety emotional states over a given time window, and the frequency of specific latent problem categories such as bullying or isolation. The server combines these factors using a scoring function that may be linear or non-linear, assigning weights to different indicators according to their relevance. For instance, the server may assign a higher weight to repeated bullying-related problems than to occasional academic stress, thereby yielding a composite risk-oriented score for each subject.

The server stores the index information in a subject-level table that includes the latest risk-oriented score, trend indicators (for example, increasing, stable, or decreasing risk), and auxiliary metrics such as the number of recent utterances analyzed. The server also maintains an inverted index or summary view that allows efficient retrieval of subjects sorted by risk-oriented score. By precomputing and storing these index values, the server reduces query time and computational load when many users simultaneously request dashboards.

The server outputs the response information and the index information via a display interface for the user. The server implements a web-based user interface framework or another graphical user interface framework to generate display screens. The server retrieves subject-level index information and detailed per-utterance analysis data from the relational database. The server composes user interface elements such as lists, tables, and graphical timelines. The server sorts the list of subjects by risk-oriented score so that subjects with higher scores appear at the top of the list. The server color-codes risk levels, provides filters based on latent problem categories, and allows the user to expand each subject entry to view recent utterances, NLP analysis summaries, and the generated emotional_state and possible_problems. The user views these displays on a user device, such as a workstation, a tablet, or a smartphone. The user can select a subject and access detailed information without manually scanning all transcripts.

In one usage example, the terminal records a child uttering, “I don't want to go to school tomorrow.” The server converts this audio into “I don't want to go to school tomorrow.” The server performs NLP and obtains, for example, sentiment=−0.9, emotions=[anxiety, sadness], feature words=[school, tomorrow]. The server constructs the following prompt sentence:
“You are an expert child psychologist.
Child's utterance: ‘I don't want to go to school tomorrow.’
NLP analysis: sentiment=−0.9 (strongly negative), emotions=[anxiety, sadness], key phrases=[school, tomorrow].
Based on this information, infer the child's emotional state and up to three possible underlying problems in daily life or the educational environment.
Output as emotional_state, possible_problems, and brief_support_suggestions.”

The generative AI model generates an output such as “emotional_state: strong anticipatory anxiety about school; possible_problems: fear of bullying, worry about a test, feeling unsupported by adults; brief_support_suggestions: talk with the child before school, screen for bullying, adjust academic pressure.” The server parses and stores this output, updates the subject's time-series data, recomputes the risk-oriented score, and places the subject higher on the prioritized list if repeated high-anxiety patterns are detected. The user accesses the dashboard and immediately sees that this subject has moved into a high-priority zone.

From a technical perspective, this arrangement improves the functioning of the computer system in several ways. The server reduces redundant processing by storing structured NLP outputs and embedding them directly into prompt sentences, instead of repeatedly re-analyzing raw text. The server achieves higher inference accuracy by feeding the generative AI model with both raw utterance text and structured features, which has been shown to reduce ambiguity and misclassification compared with models operating on raw text alone. The server improves data management by separating raw audio, transcript text, NLP features, and generative AI inferences into clearly defined tables and indices, thus enabling scalable querying and aggregation for large populations of subjects.

The use of the transformer-based generative AI model with domain-specific fine-tuning and structured prompt construction goes beyond mere human task automation. The server executes non-conventional steps: explicitly computing linguistic and emotional features, encoding them as part of the input in a controlled prompt sentence, and parsing model outputs against a predefined structural pattern. These steps are not equivalent to manual human judgment, but instead exploit the high-dimensional representations learned by the neural network and the systematic feature integration designed in software. The combined pipeline of audio capture, speech recognition, NLP feature extraction, structured prompt construction, neural inference, and time-series aggregation, implemented as a unified program on the server, yields faster processing (due to reduced repeated work and optimized data access patterns), greater consistency (due to standardized templates and parsing), and reduced communication load (because terminals transmit audio once and all subsequent processing occurs in the server-side pipeline).

The server can employ various alternative embodiments. In one alternative, the speech recognition module runs locally on the server using a neural acoustic model and a beam search decoder that operates directly on Mel-spectral features extracted by a signal processing library. In another alternative, the NLP module is implemented as a transformer encoder trained for multi-task learning, simultaneously predicting part-of-speech tags, sentiment labels, and emotion categories, thereby reducing model count and improving inference speed. In another variation, the generative AI model is replaced by a hybrid architecture comprising a transformer encoder for feature extraction and a smaller decoder or classifier that generates structured labels, thereby improving latency in resource-constrained deployments.

The server may also employ different learning strategies for the generative AI model. For example, the server, during an offline training phase, may use a loss function that combines a language modeling loss with an auxiliary loss measuring the discrepancy between predicted emotional_state vectors and ground-truth emotional_state vectors defined in an emotion embedding space. The server may use data augmentation techniques, such as back-translation or synonym replacement, to create additional training examples that preserve emotional content while varying surface text. The server thus improves robustness and reduces overfitting, leading to more reliable inference when applied to noisy or colloquial utterances.

Because the system integrates these components in a specific, non-generic way, the server realizes technical effects beyond a straightforward automation of human decision-making. The system provides improved processing speed through precomputed indices and efficient database structures, improved accuracy in risk identification through combined use of NLP features and generative AI inference, and improved computational efficiency by avoiding repeated analysis and by using multi-task models. The design also reduces network utilization by limiting data transfer between terminal and server to audio and essential metadata, while all high-volume processing, model inference, and aggregation occur on the server. Consequently, the system improves the operation of the computer system itself and provides a technical tool that supports, but does not merely replicate, human analysis of emotional and behavioral data.

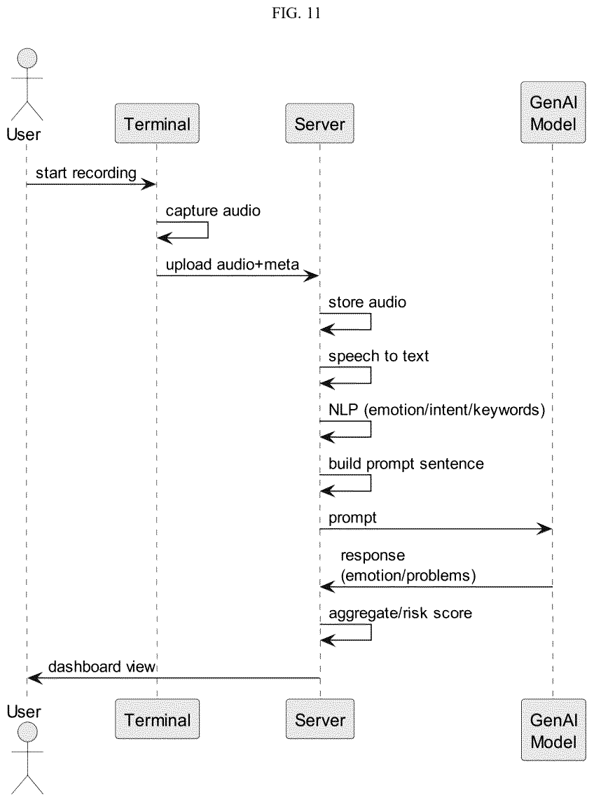

The following describes the processing flow using FIG. 11.

### Step 1:

The terminal acquires audio data of a subject and transmits it to the server.

The terminal uses a microphone and an operating-system audio capture framework to sample the subject's utterance at a fixed sampling rate (for example, 16 kHz, 16-bit PCM).

The terminal encodes the sampled audio stream into an audio file (for example, WAV format) and associates metadata such as subject ID, timestamp, and context tag.

The terminal sends an HTTP or HTTPS request to the server, with the audio file in the request body and the metadata in headers or a JSON payload.

Input: an analog speech signal produced by the subject.

Output: a digitized audio file with associated metadata, transmitted over the network to the server.

The terminal converts the analog speech waveform into discrete digital samples, groups the samples into frames, compresses or packages the frames into a file structure, and encapsulates the file and metadata into a network packet sequence addressed to the server.

### Step 2:

The server receives the audio data from the terminal and registers it in persistent storage.

The server accepts the incoming HTTP or HTTPS request using a web server framework and parses the multipart body to extract the audio file and the metadata fields.

The server stores the audio file in an object storage subsystem and creates a database record in an audio table that stores a reference to the storage location, the subject ID, the timestamp, and the context tag.

The server returns a response code to the terminal indicating successful receipt and registration.

Input: a network request containing an audio file and metadata from the terminal.

Output: a persistent audio record consisting of a storage path and indexed metadata in a database.

The server converts the incoming network byte stream into a file object, assigns a unique identifier to the audio data, and inserts a row into a relational database to map that identifier to the file location and metadata, thereby enabling future retrieval.

### Step 3:

The server converts the audio data into character string data using speech recognition processing.

The server retrieves the stored audio file from object storage based on the identifier in the database record.

The server invokes a speech recognition module, providing the audio file, language code, and configuration parameters such as sampling rate and recognition model type.

The server receives a transcription result that includes recognized text, word-level or segment-level confidence scores, and optional timing information.

The server normalizes the recognized text by applying rules such as punctuation restoration, lowercasing, and removal of extraneous tokens, then stores the resulting character string and its associated metadata in a transcript table linked to the audio record.

Input: a reference to the audio file and associated metadata.

Output: character string data representing a textual transcript of the subject's utterance, stored with confidence measures.

The server performs feature extraction on the audio signal (for example, computing Mel-frequency cepstral coefficients), feeds the feature vectors into an acoustic model and language model, decodes the most likely word sequence using a search algorithm, and then converts that sequence into a normalized text string.

### Step 4:

The server performs natural language processing on the character string data to extract linguistic and affective features.

The server reads the transcript text from the transcript table and sends it to an NLP module with instructions to execute tokenization, part-of-speech tagging, dependency parsing, sentiment analysis, emotion classification, intent classification, and key phrase extraction.

The server receives the NLP outputs including token lists, syntactic tags, sentiment scores, emotion categories, intent labels, and feature words or phrases.

The server writes these NLP results into separate database tables for emotion information, intention information, and feature word information, each row being linked to the original transcript record.

Input: normalized character string data representing the subject's utterance.

Output: structured NLP features including emotion information, intention information, and feature word information, stored as discrete fields in the database.

The server converts the text into token sequences, computes vector representations of sentences, applies classification and labeling models to estimate sentiment and intent, and ranks candidate phrases to select those with high semantic relevance as feature words.

### Step 5:

The server constructs a prompt sentence for a generative AI model based on the transcript and the extracted NLP features.

The server retrieves the transcript text, the sentiment score, the emotion labels, the intent labels, and the feature words associated with a given utterance.

The server loads a prompt template that defines a fixed structure with placeholders for utterance text, sentiment value, emotion list, key phrases, and an instruction to infer emotional state and latent problems.

The server inserts the actual values into the placeholders and generates a single prompt sentence or multi-line text block that conforms to the template.

As one example, the server generates a prompt sentence such as:
“You are an expert child psychologist.
Child's utterance: ‘I don't want to go to school tomorrow.’
NLP analysis: sentiment=−0.9 (strongly negative), emotions=[anxiety, sadness], key phrases=[school, tomorrow].
Based on this information, infer the child's emotional state and up to three possible underlying problems in daily life or the educational environment.
Output as emotional_state, possible_problems, and brief_support_suggestions.”

Input: transcript text and associated NLP features (sentiment, emotions, intent, feature words).

Output: a structured prompt sentence formatted as text for input to the generative AI model.

The server performs string formatting operations, concatenates fixed instruction phrases with variable values, ensures delimiter consistency, and validates that the assembled prompt satisfies syntactic and semantic constraints required by the generative AI model interface.

### Step 6:

The server sends the prompt sentence to a generative AI model and obtains response information including emotional state information and latent problem information.

The server transmits the prompt sentence to a generative AI model endpoint, specifying inference parameters such as maximum token count and sampling temperature.

The generative AI model, implemented as a multi-layer transformer network, internally converts the prompt sentence into token embeddings, propagates them through attention and feedforward layers, and generates a continuation text that describes the inferred emotional_state, possible_problems, and brief_support_suggestions.

The server receives the generated text and extracts target fields by detecting predefined markers or parsing the text structure defined in the prompt.

The server validates the parsed response, truncates overly long segments if necessary, and stores the emotional_state information and latent problem information in dedicated database tables that refer back to the transcript record and subject ID.

Input: a formatted prompt sentence containing the utterance and its NLP-derived features.

Output: structured response information including emotional_state information and latent problem information derived from the generative AI model's output.

The server maps the textual output into defined categories or controlled vocabularies, assigns identifiers to each inferred problem type, and records these identifiers and descriptions in the database as machine-readable fields.

### Step 7:

The server aggregates analysis results for each subject over time and computes index information including risk-oriented score information.

The server retrieves, for a given subject, a time-ordered sequence of records including sentiment scores, emotion labels, emotional_state labels, and latent problem categories over a specified time window.

The server calculates aggregate measures such as average sentiment, moving averages of negative sentiment, counts of high-anxiety states, and frequencies of specific latent problem categories.

The server applies a scoring function that assigns weighted contributions from these measures to compute a composite risk-oriented score for the subject.

The server stores the computed index information, including the risk-oriented score and trend indicators, in a subject-level index table, updating or inserting the record for the relevant subject.

Input: a time-series collection of NLP and generative AI outputs associated with a subject.

Output: index information for the subject, including at least one risk-oriented score value and associated trend metrics.

The server executes numerical operations such as summation, averaging, exponential smoothing, and weighted combination, and it quantizes the resulting continuous scores into discrete risk levels if needed for display.

### Step 8:

The server generates and outputs a display screen for the user based on the index information and detailed analysis results.

The server queries the subject-level index table to obtain a list of subjects and their risk-oriented scores, then sorts the list in descending order of risk.

The server fetches recent utterances and corresponding emotional_state and latent problem information for each subject to populate detail views.

The server composes a user interface data structure that includes a prioritized list of subjects, color-coded risk indicators, and links or summaries showing key utterances and inferred problems.

The server sends this data to the user device via a network interface and, if using a web-based interface, returns HTML and associated resources that render the dashboard in a browser.

Input: index information per subject and associated per-utterance analysis data from the database.

Output: a rendered or render-ready dataset for a display screen showing prioritized subjects and their emotional and problem-related information.

The server organizes the data into layout regions, converts numerical risk scores into visual indicators (for example, red/yellow/green), and attaches user interface actions that allow the user to select a subject and view more detailed information.

### Step 9:

The user views the display screen and determines support actions based on the presented information.

The user operates a user device to access the dashboard and observes the prioritized list of subjects and corresponding risk indicators.

The user selects a subject entry to inspect recent utterances, the inferred emotional_state, and the list of possible latent problems and brief support suggestions provided in the system output.

The user interprets these technical outputs in combination with personal observations and domain knowledge, and then decides on specific actions such as scheduling a counseling session or contacting a guardian.

Input: the displayed response information and index information rendered on the user device.

Output: a human decision regarding support actions for one or more subjects, optionally documented back into the system via user input.

The user evaluates the computer-generated indicators and structured suggestions, identifies high-priority cases efficiently due to the risk-based ordering, and records chosen actions or notes through input fields, which the system can store as additional contextual data for future processing.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented support systems for children's well-being mainly rely on static questionnaires or manually entered text and do not effectively utilize continuous multimodal data such as spontaneous speech and behavioral images captured in real time. As a result, existing systems are limited in their ability to detect subtle or rapidly changing emotional states of a child and to generate timely, context-appropriate guidance for guardians or educators. In particular, three technical problems arise.

First, conventional information processing pipelines are typically designed either for speech recognition or for simple sentiment tagging, but not for dynamic orchestration of heterogeneous components including audio-to-text conversion, language analysis, emotion analysis, image analysis, and large-scale generative models. The absence of an integrated control flow causes inefficiencies such as redundant processing, inconsistent feature extraction across modalities, and latency that degrades the responsiveness of the system. Consequently, computer resources are not optimally utilized, and the system fails to provide real-time notifications at scale.

Second, conventional systems do not provide a technical mechanism for constructing and adapting prompt sentences supplied to a generative AI model in a systematic manner based on structured feature information derived from multimodal analysis. In many cases, prompt sentences are fixed or manually engineered and do not reflect the current emotional features, behavioral indicators, or historical feedback from guardians and educators. This leads to unstable output quality, reduced relevance of generated guidance, and unpredictable computational load in the generative AI model, thereby limiting the practical usability and scalability of such systems.

Third, typical architectures do not exploit feedback signals from end users to improve the internal processing pipeline and the interaction between the processor and the generative AI model. Guardians' and educators' responses to notifications (for example, whether a proposed guidance message was useful) are not fed back into the system as machine-usable operation information. As a result, the system cannot adapt the structure of subsequent prompt sentences or the representation format of guidance information. This causes persistent mismatches between generated content and user needs and prevents iterative optimization of the computer-implemented process.

Accordingly, there is a need for an improved computer-implemented system that efficiently integrates audio and image acquisition, conversion of audio to character information, language and emotion analysis, image analysis, and adaptive prompt construction for a generative AI model, in combination with user feedback processing. Such a system should reduce processing redundancy, stabilize and enhance the quality of generated guidance, and enable scalable and timely notifications, thereby improving the overall performance and technical effect of the underlying computer technology used for child-support applications.

The specific processing by the specific processing unit 290 of the data processing device 12 in Application Example 1 is realized by the following means.

The present invention provides a server comprising a processor configured to receive audio information and image information via an input/output device, execute a conversion process to transform the audio information into character information, execute language analysis processing and emotion analysis processing on the character information to extract feature information related to an emotional state or a concern of a child, execute image analysis processing on the image information to extract additional feature information related to a facial expression or a behavior of the child, integrate the feature information and the additional feature information, generate a prompt sentence for a generative AI model based on the integrated feature information so as to cause the generative AI model to generate an estimation result of the emotional state or the concern of the child and guidance information for a guardian or an educator, input the prompt sentence into the generative AI model, acquire response information including the estimation result and the guidance information output from the generative AI model, execute communication processing to transmit the response information as a notification to a terminal device of the guardian or the educator, and further acquire response operation information from the guardian or the educator and update at least one of a structure of the prompt sentence and a representation format of the guidance information based on the response operation information. This enables the server to orchestrate multimodal analysis and generative processing in a single integrated pipeline, reduce redundant computation, adapt prompt construction and guidance generation to real-time emotional features and user feedback, and thereby improve the technical performance, responsiveness, and scalability of computer-implemented child-support systems.

The term “processor” refers to a hardware computation element, such as a central processing unit or a processing circuit, that executes machine-readable instructions to perform the functions described in the claims.

The term “input/output device” refers to an apparatus, such as a microphone, camera, display, or network interface, that receives information from a user or an external environment and/or outputs information to the user or an external device.

The term “audio information” refers to electronic data representing sound signals, including spoken utterances of a child, which are acquired via an input/output device and processed in digital form.

The term “image information” refers to electronic data representing still images or moving images, including a facial expression or a behavior of a child, which are acquired via an input/output device and processed in digital form.

The term “character information” refers to electronic data representing textual content obtained by converting audio information into a text-based format that can be analyzed by language processing.

The term “conversion process” refers to computer-implemented processing that transforms audio information into character information, including operations such as decoding, recognition, and formatting of speech into text.

The term “language analysis processing” refers to computer-implemented processing that analyzes character information to identify linguistic structures, such as tokens, parts of speech, phrases, topics, or entities, for subsequent use in feature extraction.

The term “emotion analysis processing” refers to computer-implemented processing that analyzes character information to infer or classify emotional states, such as positivity, negativity, anxiety, or sadness, associated with the content of the character information.

The term “image analysis processing” refers to computer-implemented processing that analyzes image information to detect or classify visual attributes, including facial expressions, postures, gestures, or scene context, for use as additional feature information.

The term “feature information” refers to structured data elements derived from language analysis processing or emotion analysis processing that characterize an emotional state or a concern of a child.

The term “additional feature information” refers to structured data elements derived from image analysis processing that characterize a facial expression or a behavior of a child, and that are used together with feature information.

The term “integrate” refers to a computer-implemented operation that combines feature information and additional feature information into a unified data representation for subsequent processing.

The term “prompt sentence” refers to a machine-generated textual instruction or query that is supplied to a generative AI model and that encodes feature information and context to cause the generative AI model to produce a desired output.

The term “generative AI model” refers to a trained machine learning model, such as a large-scale language model, configured to generate natural-language output or other data in response to an input including a prompt sentence.

The term “estimation result” refers to information output by the generative AI model that represents an inferred emotional state or an inferred concern of a child based on a prompt sentence and associated feature information.

The term “guidance information” refers to information output by the generative AI model that represents advice, recommendations, or supportive messages intended for a guardian or an educator in view of a child's estimated emotional state or concern.

The term “response information” refers to data output from the generative AI model that includes at least the estimation result and the guidance information and that is transmitted by the processor as part of a notification.

The term “communication processing” refers to computer-implemented operations for transmitting or receiving data over a communication network, including the transmission of response information to a terminal device.

The term “terminal device” refers to an electronic device used by a guardian or an educator, such as a smartphone, tablet, or personal computer, that can receive notifications and display response information.

The term “guardian” refers to a person having responsibility for the care or supervision of a child, including a parent or legal custodian, who receives guidance information from the system.

The term “educator” refers to a person involved in educational activities for a child, such as a teacher or school staff member, who receives guidance information from the system.

The term “notification” refers to an electronic message, such as a push notification or an in-application message, transmitted from the server to a terminal device to present response information to a guardian or an educator.

The term “response operation information” refers to data indicating an operation performed by a guardian or an educator in response to a notification, including selections, confirmations, or input provided through a user interface of a terminal device.

The term “structure of the prompt sentence” refers to the internal organization or pattern of a prompt sentence, including ordering, segmentation, or formatting of textual elements supplied to the generative AI model.

The term “representation format of the guidance information” refers to the manner in which guidance information is expressed or formatted, including length, style, tone, or level of detail of the generated content.

In one embodiment, a server implements the claimed system using a general-purpose computing platform. The server comprises at least one processor, a main memory, a non-volatile storage device, and a network interface. The server operates under a server operating system and executes application software modules written, for example, in a high-level programming language. The server is connected via a communication network to at least one terminal operated by a user.

A terminal is implemented as a mobile information processing apparatus, such as a smartphone or a tablet, or as a general-purpose personal computer. The terminal comprises a processor, a memory, a display device, a microphone, a camera, and a wireless or wired communication interface. The terminal executes a client application that communicates with the server, acquires audio information and image information, and displays notifications to a user. A user operates the terminal as a guardian, an educator, or a child.

The server manages multiple functional modules stored in the non-volatile storage and loaded into the main memory for execution by the processor. In one example, the modules include an audio acquisition interface module, an audio-to-text conversion module, a language analysis module, an emotion analysis module, an image analysis module, a feature integration module, a prompt generation module, a generative AI interface module, a response post-processing module, a notification control module, and a feedback adaptation module. Each module is implemented as a software component having defined input and output data structures, and the modules exchange data via shared in-memory objects and a message queue managed by the server.

The terminal acquires audio information by controlling the microphone hardware through an operating system audio API. The terminal samples the acoustic signal at a predetermined sampling rate and bit depth and stores digitized samples in a circular buffer. The terminal encapsulates the digitized samples into an audio information record that includes metadata such as a child identifier, a timestamp, and a language code. The terminal transmits the audio information record to the server over a secure communication channel established via the communication interface.

The terminal acquires image information by controlling the camera hardware through an operating system camera API. The terminal captures a still image or a short sequence of frames and encodes the pixel data into a compressed representation. The terminal constructs an image information record containing the compressed pixel data and metadata similar to that of the audio information. The terminal transmits the image information record to the server using the same secure communication mechanism.

The server receives the audio information record through the audio acquisition interface module. The server stores the audio data into a structured data object in memory, which includes fields for the raw waveform, the sampling attributes, and the associated metadata. The server then invokes the audio-to-text conversion module. In one embodiment, the audio-to-text conversion module communicates with an external speech recognition service. The server transmits the raw waveform or a compressed representation to the external service via an application programming interface, together with parameters specifying the sampling attributes and desired language. The external service returns recognized text, which the server stores as character information in a text field of the data object.

The server executes the language analysis module using character information as input. The language analysis module applies a tokenization operation to divide the character information into tokens based on language-specific rules. The server then performs part-of-speech tagging to assign grammatical categories to each token. The server extracts syntactic dependencies and phrase-level structures. For example, the server identifies that in the character information “I don't want to go to school,” the token sequence forms a negative intention related to an educational environment. The server stores the linguistic features as a language feature vector, where each dimension may correspond to token-level statistics, grammatical patterns, or identified key phrases.

The server executes the emotion analysis module on the same character information and the language feature vector. In one embodiment, the server uses a trained neural network classifier to compute emotion scores. The neural network may be a multi-layer architecture with an embedding layer, one or more recurrent or attention-based layers, and a classification layer. The embedding layer maps tokens into continuous vectors; the intermediate layers capture sequence-level context; and the classification layer outputs probability values for emotion categories such as sadness, anxiety, anger, and joy. The server stores these probability values as emotion feature elements. The emotion analysis module may also compute a sentiment polarity value and an intensity value, which are stored in numeric fields associated with the data object.

The server receives the image information record and invokes the image analysis module. In one embodiment, the image analysis module uses a convolutional neural network to process the pixel data. The convolutional neural network contains multiple layers of convolution, normalization, non-linear activation, and pooling, followed by one or more fully connected layers. The server feeds the compressed image representation into the network, which outputs feature vectors representing facial expressions, posture, and estimated activity context. For instance, the network may output a vector indicating likelihood values for facial emotions (e.g., happy, neutral, sad) and numerical descriptors for body pose and proximity to other persons. The server stores these descriptors as additional feature information in association with the image information.

The server executes the feature integration module to combine the language feature vector, the emotion feature elements, and the additional feature information into an integrated feature representation. In one embodiment, the server normalizes each feature set to a common scale and performs a concatenation operation to create an integrated vector. Alternatively, the server may apply a learned transformation, such as a feedforward network, that maps the combination of textual and visual features into a compact latent representation. The integrated feature representation is stored in a structured field, and each dimension of the representation is associated with a semantic meaning, such as “school-related concern” or “social isolation indicator.”

The server executes the prompt generation module to construct a prompt sentence for a generative AI model. The prompt generation module reads the integrated feature representation and determines which elements exceed predetermined thresholds or satisfy certain rules. Based on these criteria, the server selects predefined templates and inserts context variables. For example, if a school-related concern indicator and an anxiety indicator are both above thresholds, the server may generate a prompt sentence such as:
“You are an assistant that analyzes children's feelings. The following is a child's utterance and analysis results. First infer possible emotions and worries, then generate one or more gentle and supportive messages for a guardian. Utterance: ‘I don't want to go to school.’ Sentiment: negative. Emotion: anxiety, avoidance. Topic: school. Output clearly separated sections: (1) Possible emotions and worries, (2) Suggested supportive message.”

In another example, the server may generate a simpler prompt sentence:
“Child's utterance: ‘I don't want to go to school.’ Analyze what kind of emotions or worries the child might have, and propose a short message that a guardian can say. Respond in simple language suitable for guardians.”

The server can store multiple prompt templates and select between them using heuristic rules or learned policies. By incorporating both textual and visual features into the prompt sentence, the server conditions the generative AI model on a richer structured context, which improves the relevance and consistency of the generated output compared with manually crafted, static prompts.

The server interfaces with a generative AI model via the generative AI interface module. In one embodiment, the generative AI model is a transformer-based neural network that accepts tokenized versions of prompt sentences and produces token sequences as output. The server converts the prompt sentence into a sequence of tokens using a tokenizer consistent with the model's vocabulary. The server passes these tokens to the generative AI model along with generation parameters such as a maximum output length and sampling configuration. The generative AI model internally applies multiple layers of self-attention and feedforward transformations, computing output token probabilities based on learned weights. The model generates an output token sequence, which the server decodes into response information in natural language.

During training of the generative AI model, a dataset of child-related utterances, associated feature representations, and expert-written guidance messages can be used. The model may be trained using a maximum likelihood objective, where the loss function is defined as a negative log-likelihood of target tokens conditioned on prompt tokens. The server or a separate training system updates the model weights using gradient-based optimization, such as stochastic gradient descent or an adaptive method. Data augmentation techniques, such as paraphrasing utterances or simulating noise in audio-derived text, can be used to increase robustness.

The server receives response information from the generative AI model through the generative AI interface module. The response information includes an estimation result describing likely emotions or concerns of the child, and guidance information describing recommended supportive messages. The server passes this response information to the response post-processing module. The response post-processing module applies rule-based filters to remove inappropriate language or to enforce length constraints. The server may split the response information into sections, annotate it with confidence values, and store it in a database together with the original feature representation.

The server executes the notification control module to transmit response information to a terminal of a guardian or an educator. The notification control module formats the response information into a notification payload containing a summary and a detailed description. The server sends the payload via a push notification service or through a direct communication channel. The terminal receives the notification, displays a brief summary on the display device, and allows the guardian or the educator to open a detailed view showing the estimation result and the guidance information.

The user, acting as a guardian or an educator, operates the terminal to view the notification content and to provide feedback. The terminal displays user interface elements such as buttons or selection lists allowing the user to indicate whether the guidance was helpful, whether further assistance is needed, or whether specific actions will be taken. The user selects options or enters short comments. The terminal transmits this response operation information to the server.

The server receives the response operation information in the feedback adaptation module. The server analyzes patterns in the feedback over multiple events, correlating user satisfaction with characteristics of prompt sentences and guidance information. The server updates internal parameters controlling template selection, feature thresholds, and representation formats. For example, if users consistently indicate that responses are too long, the server can adjust prompt sentences to specify shorter outputs, or can update generation parameters to limit the number of tokens. If feedback indicates that certain types of guidance are not useful, the server can modify the templates to emphasize alternative strategies. By doing so, the server dynamically adapts the structure of prompt sentences and the representation format of guidance information.

This adaptation provides a technical effect beyond human manual editing. The server uses quantified feedback and integrated feature representations to automatically reconfigure the prompt generation behavior and notification formatting. As a result, the system improves computational efficiency by reducing unnecessary content generation, and improves accuracy of guidance by aligning outputs with user preferences and observed child states. The closed-loop adaptation mechanism enables the computer system to converge toward more effective use of computational resources and more precise emotional estimation, rather than merely automating static human workflows.

The described system yields multiple technical advantages. The integrated feature representation enables the server to avoid redundant processing by reusing a single compact vector in multiple downstream operations, which reduces memory accesses and computation compared with separate pipelines. The early fusion of textual and visual features allows the generative AI model to be conditioned on a lower-dimensional, semantically meaningful context, which reduces the need for long, verbose prompt sentences and thereby lowers token processing costs and latency. The combination of language analysis and emotion analysis performed by dedicated modules before the generative AI model invocation improves robustness: errors in audio-to-text conversion are partially compensated by structural and emotional cues extracted from context, leading to lower overall misclassification rates of the child's emotional state.

The system further improves communication efficiency between the server and the terminal. Because the server transmits compact notifications and does not require raw audio or image data to be repeatedly sent once the feature representation has been computed, network bandwidth consumption is reduced. Additionally, the server can cache and index feature representations in the database to support later retrieval and aggregated analysis without reprocessing the original media, contributing to reduced processing load and faster access times.

The architecture described above is not limited to a single implementation. In another embodiment, the server may execute the language analysis module and emotion analysis module using different algorithmic combinations, such as a rule-based sentiment analyzer supplemented with a smaller neural classifier. In another variation, the image analysis module may be replaced with a non-neural feature extractor that computes hand-crafted descriptors; the integrated feature representation can still be formed by combining these descriptors with textual features. In yet another embodiment, the generative AI model may be executed on the server itself, using a locally deployed transformer network optimized for reduced memory consumption, while the external services are used only for speech and vision processing.

The terminal may differ across embodiments. In some cases, the terminal may be a dedicated handheld device deployed in an educational institution, with restricted functionality, where the server performs most heavy processing. In other cases, the terminal may perform preliminary feature extraction, such as computing on-device spectrogram features or low-resolution image features, and send these features rather than raw media to the server. This distributed processing further reduces network load and enables the server to handle a larger number of concurrent terminals.

By utilizing a structured pipeline that decomposes processing into audio acquisition, conversion, linguistic and emotional analysis, visual analysis, feature integration, adaptive prompt generation, generative model invocation, post-processing, notification control, and feedback adaptation, the server achieves improvements in processing speed, accuracy of emotion estimation, and efficient use of computational and communication resources. The system therefore demonstrates a specific technical implementation that improves computer technology itself, including data representation efficiency, model conditioning, and adaptive configuration of complex machine learning components, rather than merely automating human reasoning or business procedures.

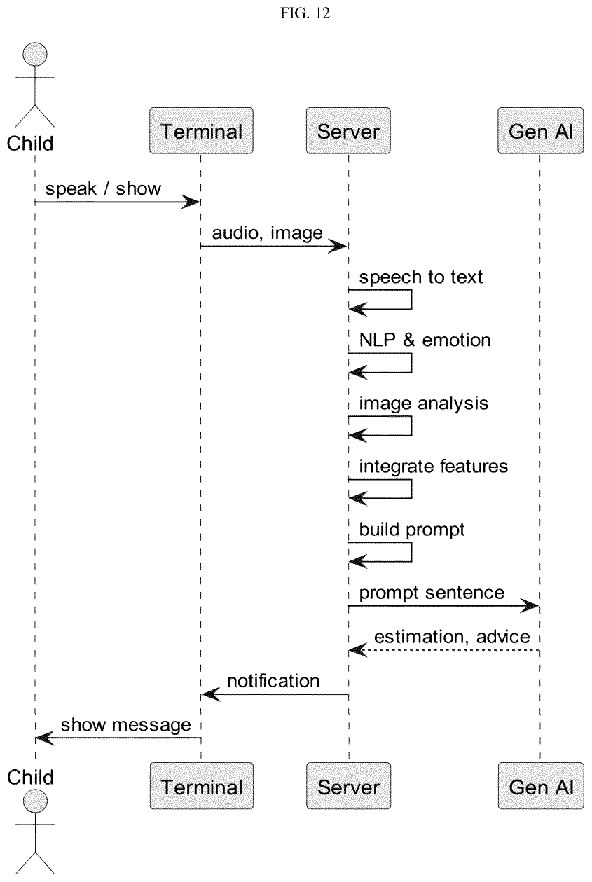

The following describes the processing flow using FIG. 12.

### Step 1:

The terminal acquires audio information from the user (child) via a microphone.

The terminal receives, as input, an analog audio signal corresponding to the child's utterance, such as “I don't want to go to school.” The terminal controls an audio driver to sample the analog signal at a predetermined sampling rate and bit depth (for example, 16 kHz, 16-bit PCM) and converts the signal into a digital waveform array. The terminal packages the waveform array together with metadata (child identifier, timestamp, language code) into an audio information record. The terminal outputs this audio information record as a structured digital object stored in a buffer ready for network transmission.

### Step 2:

The terminal acquires image information from the user (child) via a camera.

The terminal receives, as input, light captured by the camera sensor corresponding to the child's facial expression or behavior. The terminal controls a camera API to capture a frame or a short sequence of frames and converts the raw sensor data into a compressed image format (for example, JPEG or H.264). The terminal associates metadata (child identifier, timestamp, capture context) with the compressed image data to form an image information record. The terminal outputs the image information record as a digital object that can be transmitted to the server.

### Step 3:

The terminal transmits the audio information and image information to the server.

The terminal receives, as input, the audio information record and the image information record created in Step 1 and Step 2. The terminal opens a secure communication session (for example, HTTPS) to the server and serializes the records into a request payload (for example, JSON or multipart form). The terminal sends the payload to a predefined server endpoint and waits for an acknowledgment. The terminal outputs the records onto the network so that the server can receive and process them.

### Step 4:

The server receives and stores the audio information and image information.

The server receives, as input, the network request containing the audio information record and the image information record. The server validates authentication data and checks sizes and formats of the incoming data. The server writes the raw audio waveform and compressed image data into storage or memory, and creates an internal data structure that contains pointers to these data blocks and associated metadata (child identifier, timestamps, language). The server outputs an integrated media object that encapsulates audio and image information for subsequent processing steps.

### Step 5:

The server converts the audio information into character information.

The server receives, as input, the integrated media object including the audio waveform. The server passes the waveform to an audio-to-text conversion routine, which may call an external speech recognition engine. The server encodes the waveform according to the engine's specification and sends it with language parameters. The engine returns recognized text. The server parses the recognition result and extracts a character string such as “I don't want to go to school.” The server attaches this character string to the integrated media object as character information. The server outputs the updated media object that now includes both audio data and corresponding text data.

### Step 6:

The server executes language analysis processing on the character information.

The server receives, as input, the character information from Step 5. The server tokenizes the text into words and punctuation, assigns part-of-speech tags, and identifies grammatical relations and key phrases. For example, the server detects that “don't want to go” is a negative intent verb phrase and that “school” is a location or topic noun. The server aggregates these findings into a language feature vector, where elements represent features such as detected topic, presence of negation, and intensity indicators. The server attaches the language feature vector to the media object and outputs this enriched object for further analysis.

### Step 7:

The server executes emotion analysis processing on the character information and language features.

The server receives, as input, the character information and the language feature vector. The server feeds tokenized text and language features into an emotion classification model, such as a neural network that outputs probabilities for emotion categories (for example, sadness, anxiety, fear). The server performs matrix multiplications and non-linear activations within the model to compute emotion scores and sentiment polarity values. Based on these calculations, the server may determine that the utterance has high probability of anxiety and a negative sentiment. The server stores these emotion scores as emotion feature elements linked to the media object. The server outputs the media object now containing both language and emotion feature information.

### Step 8:

The server executes image analysis processing on the image information.

The server receives, as input, the compressed image data from the media object. The server decodes the compressed format to obtain pixel data and feeds the pixel data into an image analysis algorithm. The server applies convolutional filters and pooling operations to the image pixels to detect patterns corresponding to facial expressions and body postures. For example, the server may compute likelihood scores that the child appears sad or isolated. The server encodes these visual findings as additional feature information, such as numeric values representing emotion probabilities and posture descriptors. The server attaches the additional feature information to the media object and outputs this visually enriched object.

### Step 9:

The server integrates textual features, emotional features, and visual features.

The server receives, as input, the language feature vector, the emotion feature elements, and the additional feature information from image analysis. The server normalizes each feature set to a common scale and concatenates them into a single integrated feature vector. The server may further apply a transformation matrix to reduce dimensionality and emphasize relevant components, generating a compact latent representation. The server assigns this integrated feature vector to the media object as integrated feature information. The server outputs the media object containing a unified representation of the child's state across modalities.

### Step 10:

The server generates a prompt sentence for a generative AI model based on the integrated feature information.

The server receives, as input, the integrated feature vector and the original character information. The server applies decision rules to determine which template to select and which feature values to embed into the prompt. For example, if the integrated feature vector indicates a high school-related concern and strong anxiety, the server selects a template that requests analysis of school-related emotions. The server then fills template placeholders with the utterance text and feature labels to form a prompt sentence, such as:
“You are an assistant that analyzes children's feelings. The following is a child's utterance and analysis results. First infer possible emotions and worries, then generate one or more gentle and supportive messages for a guardian. Utterance: ‘I don't want to go to school.’ Sentiment: negative. Emotion: anxiety, avoidance. Topic: school. Output clearly separated sections: (1) Possible emotions and worries, (2) Suggested supportive message.”

The server outputs this constructed prompt sentence as a text string ready for input to the generative AI model.

### Step 11:

The server supplies the prompt sentence to the generative AI model and obtains response information.

The server receives, as input, the prompt sentence from Step 10. The server tokenizes the prompt according to the vocabulary of the generative AI model and encodes the tokens into numerical identifiers. The server feeds this token sequence into the generative AI model, which computes internal attention weights and layer outputs to predict a sequence of response tokens. The server decodes the output token sequence back into natural-language text. The resulting text includes an estimation result describing possible emotions and worries and guidance information proposing supportive messages. The server separates these components and stores them as response information fields. The server outputs the media object augmented with the estimation result and guidance information.

### Step 12:

The server performs post-processing and prepares notification content.

The server receives, as input, the estimation result and guidance information. The server applies filtering rules to remove inappropriate wording or to shorten overly long sections. The server then generates a notification summary (for example, a short title and a brief message) and a detailed body containing more complete guidance text. The server encapsulates these elements into a notification object that includes identifiers linking back to the original media object. The server outputs the notification object for transmission to a terminal.

### Step 13:

The server transmits the notification object to a terminal of a guardian or an educator.

The server receives, as input, the notification object from Step 12. The server selects a communication path (for example, a push notification service) based on terminal type and user registration data. The server formats the notification object into a protocol-specific message, including summary fields, detailed fields, and identifiers. The server then sends this message over the network to the terminal. The server outputs the notification onto the communication channel where the terminal can receive it.

### Step 14:

The terminal receives and displays the notification to the user (guardian or educator).

The terminal receives, as input, the notification message from the server via the communication interface. The terminal parses the message to extract the summary and detailed content, and stores associated identifiers. The terminal displays a notification banner or alert containing the summary and, upon user interaction, opens an application screen showing the detailed estimation result and guidance information on the display device. The terminal outputs a rendered user interface that the guardian or educator can read and operate.

### Step 15:

The user provides feedback by operating the terminal, and the terminal transmits response operation information to the server.

The user receives, as input, the displayed guidance and estimation result and decides how to respond. The user taps interface elements such as “Helpful,” “Too long,” or “Need different advice,” or selects an option describing intended action. The terminal records these selections as response operation information and may also capture optional text comments entered by the user. The terminal then packages the response operation information into a data record and transmits it back to the server via a secure communication channel. The terminal outputs the response operation record onto the network for further processing.

### Step 16:

The server updates prompt generation and guidance formatting based on response operation information.

The server receives, as input, the response operation information from the terminal. The server analyzes the feedback data by aggregating it over multiple events and correlating it with corresponding prompt templates and guidance outputs. The server updates internal parameters controlling template selection, feature thresholds, and formatting rules; for example, reducing default output length when many users mark responses as too long, or altering emphasis when certain guidance types are consistently rated as unhelpful. The server stores the updated parameters in configuration storage and uses them in subsequent executions of the prompt generation module and response post-processing module. The server outputs revised configuration settings that modify future processing behavior of the system.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented support systems for children's mental states typically rely on simple keyword matching, static rule sets, or generic dialogue engines. Such systems have several technical limitations. First, a processor generally treats input utterances or text from a child as unstructured character strings, without performing context-aware emotional analysis. As a result, the processor fails to derive structured emotional state information, such as categories of inferiority, anxiety, or self-esteem, and cannot reliably associate such emotional states with situation information including living environment, relationships, and personal worries.

Second, existing architectures do not provide a systematic mechanism in which the processor dynamically generates and manages prompt sentences for a generative AI model based on extracted emotional state information. In many cases, a generative model is invoked with manually crafted or static prompts. This leads to unstable output quality, difficulty in controlling vocabulary and expression style for different developmental stages of children, and inefficient use of computing resources because the generative model cannot be guided by precise, machine-generated conditions.

Third, conventional systems generally do not incorporate user feedback, such as evaluations of support information provided to children, into the internal processing pipeline. In particular, there is no integrated mechanism for a processor to acquire evaluation information or feedback information from users (for example, guardians or educators) and automatically reflect such information in subsequent generation processes of prompt sentences or emotional state information. This absence of feedback-driven adaptation limits the ability of the computer system to improve its internal models and data processing over time, thereby constraining both accuracy and relevance of generated support information.

Accordingly, there is a need for an improved computer-implemented system and method in which a processor: (i) converts utterance information into structured emotional state information by language processing; (ii) automatically constructs and conditions prompt sentences to a generative AI model using emotional and situation information; and (iii) incorporates user feedback into the generation processes. Such a system should technically enhance the way the processor analyzes language input, controls a generative AI model through machine-generated prompt sentences, and iteratively optimizes its output using feedback, thereby improving the overall performance, robustness, and adaptability of the underlying computing platform.

The specific processing by the specific processing unit 290 of the data processing device 12 in Example 2 is realized by the following means.

The present invention provides a server comprising a processor configured to receive, via an information input/output interface, utterance information or character information relating to a child from a user; convert audio information included in the utterance information into character information by using a speech processing function, and perform language processing on the character information to extract emotional state information indicating a mental state and a situation of the child; generate, on the basis of the emotional state information, a prompt sentence to be input to a generative AI model, the prompt sentence embedding at least one of living-environment information, relationship information, and personal-worry information associated with the emotional state information and including condition information specifying vocabulary limitations and expression limitations according to a developmental stage of the child; input the prompt sentence with the condition information to the generative AI model to cause the generative AI model to generate support information including a plurality of support-information candidates that satisfy the condition information; present the support information to the user; acquire evaluation information or feedback information from the user with respect to the support information; and reflect the evaluation information or the feedback information in at least one of a generation process of subsequent prompt sentences and a generation process of subsequent emotional state information. This enables the server to technically improve computer-based emotional analysis and response generation by transforming unstructured utterance data into structured emotional state representations, by automatically producing and refining machine-generated prompt sentences that control the behavior of the generative AI model under explicit conditions, and by adaptively updating internal processing based on user feedback, thereby enhancing the accuracy, consistency, and context-appropriateness of support information generated by the computing system.

The term “utterance information” refers to information representing sounds, speech, or vocal expressions provided by or on behalf of a child, including audio signals captureable by an input device and any associated metadata.

The term “character information” refers to information represented as text data, including sequences of characters obtained by converting audio signals, and including symbols, letters, and punctuation storable and processable by an information processing device.

The term “child” refers to a human subject in a developmental stage prior to adulthood, including infants, toddlers, school-age individuals, and adolescents.

The term “user” refers to a human operator who interacts with the system, including guardians, educators, counselors, or other persons authorized to input information about a child and to receive support information from the system.

The term “information input/output interface” refers to a hardware and/or software component that enables acquisition of input information from the user and provision of output information to the user, including, for example, a graphical user interface, an application programming interface, a network interface, a display unit, and an audio input/output unit.

The term “audio information” refers to information representing acoustic signals, including digitized waveforms, encoded audio files, and streaming audio data that can be processed by a speech processing function.

The term “speech processing function” refers to a processing function implemented by hardware and/or software that performs at least one of capturing, encoding, decoding, recognizing, or transforming audio information corresponding to human speech, including speech recognition processing that converts spoken language into character information.

The term “language processing” refers to a computational procedure for analyzing and processing character information representing natural language, including at least one of tokenization, morphological analysis, syntactic analysis, semantic analysis, sentiment analysis, and extraction of linguistic features.

The term “emotional state information” refers to structured information indicating a mental state and a situation of a child, including information representing emotion categories, emotion intensities, inferred causes, and associated contextual factors.

The term “mental state” refers to an internal psychological condition of a child, including affective, cognitive, and attitudinal aspects such as sadness, anxiety, inferiority, and self-esteem.

The term “situation” refers to a context or circumstance associated with the mental state of a child, including environmental, relational, and personal conditions that may influence or be inferred from the child's expressions.

The term “prompt sentence” refers to a text-based instruction, including one or more sentences or structured segments, generated by the processor for input to a generative AI model in order to control, guide, or condition the output of the generative AI model.

The term “generative AI model” refers to a computational model implemented by hardware and/or software that, in response to input data including a prompt sentence, generates new data such as text, symbols, or structured information by using learned statistical or machine-learned relationships.

The term “support information” refers to information generated by the generative AI model based on a prompt sentence and emotional state information, including advice messages, encouragement phrases, explanatory texts, and other content configured to assist a user in supporting a child's mental state.

The term “support-information candidate” refers to one of a plurality of alternative units of support information generated by the generative AI model, each candidate being a distinct message or content item suitable for selection and presentation to the user.

The term “evaluation information” refers to information indicating a user's assessment of support information, including ratings, selections, approvals, disapprovals, or other measures of usefulness, appropriateness, or effectiveness.

The term “feedback information” refers to information provided by the user regarding system outputs or child responses, including comments, annotations, modification histories, and other qualitative or quantitative data used to improve subsequent processing.

The term “living-environment information” refers to information related to a child's physical and social environment, including home, school, community, and daily living conditions that can influence or describe the child's situation.

The term “relationship information” refers to information about a child's interpersonal connections, including relationships with family members, peers, teachers, and other individuals in the child's social network.

The term “personal-worry information” refers to information about individual concerns, anxieties, or internal problems experienced by a child, including worries about performance, self-image, or future events.

The term “condition information” refers to information specifying constraints or requirements applied to the behavior or output of the generative AI model, including vocabulary limitations, expression limitations, target tone, or style parameters.

The term “vocabulary limitations” refers to constraints that restrict the set, complexity, or level of words to be used in generated support information, for example to match a developmental stage or comprehension level of a child.

The term “expression limitations” refers to constraints that restrict the style, form, or type of expressions used in generated support information, including prohibitions on certain phrases and requirements for politeness, empathy, or non-judgmental wording.

The term “developmental stage of the child” refers to a classification of a child's maturation level, including age range, cognitive development, and educational stage, used to adapt language, content, and conditions for generated support information.

The term “expression patterns” refers to recurring linguistic constructions detectable in character information, including combinations of words, grammatical structures, or phrases that indicate comparison, self-evaluation, or evaluation by others.

The term “comparison expressions” refers to linguistic expressions in which a child compares themselves with other individuals or groups, including phrases indicating relative ability, appearance, performance, or value.

The term “self-evaluation expressions” refers to linguistic expressions in which a child describes or judges themselves, including assertions about their own ability, worth, or characteristics.

The term “other-evaluation expressions” refers to linguistic expressions in which a child refers to evaluations, opinions, or judgments made by other persons about the child.

The term “emotion category information” refers to information that classifies emotional state information into predefined categories, including categories such as inferiority, anxiety, and self-esteem, and optionally including subcategories or intensity levels.

The term “inferiority feeling” refers to an emotion category representing a child's perception of being less capable, less valuable, or less successful than others.

The term “anxiety feeling” refers to an emotion category representing a child's experience of worry, nervousness, or apprehension about real or imagined events or evaluations.

The term “self-esteem feeling” refers to an emotion category representing a child's sense of self-worth, confidence, and positive or negative evaluation of themselves.

The term “server” refers to an information processing apparatus, including at least one processor, memory, and communication interface, configured to execute the procedures of receiving, processing, and outputting data as described in the system.

The term “processor” refers to a hardware element, such as a central processing unit, graphics processing unit, or other computing circuitry, or a combination thereof, configured to execute instructions and perform the functions described in relation to the system.

### A. Overall Configuration of the System

The server includes at least one processor, a memory, and a network interface. The server is realized, for example, on a general-purpose computing platform such as a rack-mounted computing device or a virtual machine instance in a computing infrastructure. The processor executes an operating system such as a general-purpose server operating system, and executes middleware and application software including a web server, an application server, a database management system, and a natural language processing module.

The terminal includes at least one processor, a memory, an audio input device, a display device, and a network interface. The terminal is realized, for example, as a smartphone, a tablet terminal, or a notebook-type information processing device. The terminal executes an operating system such as a mobile operating system or a desktop operating system, and executes an application program that communicates with the server via a communication network such as the Internet or a mobile communication network.

The server and the terminal communicate with each other using a communication protocol such as HTTP or HTTPS. The server provides an application programming interface for transmitting and receiving structured data such as JavaScript Object Notation between the terminal and the server. The server stores data such as utterance information, character information, emotional state information, and support information in a storage device such as a relational database or an object storage device.

### B. Hardware and Software Configuration

The server uses a processor such as a central processing unit. The server memory stores executable modules including:
(1) a communication module that controls transmission and reception of data with the terminal via the network interface,
(2) a speech processing module that performs speech recognition on audio information,
(3) a language processing module that performs natural language processing on character information,
(4) an emotional state estimation module that generates emotional state information,
(5) a prompt sentence generation module that generates a prompt sentence for a generative AI model,
(6) a generative AI interface module that communicates with a generative AI model,
(7) a support information generation module that selects and formats support information, and
(8) a feedback processing module that processes evaluation information and feedback information.

The speech processing module uses a speech recognition library or service. The server uses, for example, an external speech recognition service provided via an application programming interface or an in-house speech recognition engine based on a deep neural network. The server converts incoming audio information into a waveform representation, applies pre-processing such as noise reduction, and inputs a sequence of feature vectors such as Mel-frequency cepstral coefficients to an acoustic model and a language model to obtain character information.

The generative AI interface module communicates with a generative AI model that is implemented as a large-scale neural network having a transformer architecture. The generative AI model includes an embedding layer that converts tokens of the prompt sentence into continuous vectors, a plurality of encoder-decoder layers each having multi-head self-attention, feed-forward sublayers, and normalization layers, and an output layer that outputs a probability distribution over a vocabulary. The generative AI model is trained in advance on a large corpus of text data using a learning algorithm such as stochastic gradient descent or Adam optimization, minimizing a loss function such as cross entropy between predicted tokens and ground-truth tokens.

The language processing module uses a natural language processing library such as a tokenization engine, a part-of-speech tagger, and a dependency parser. The server can use, for example, an open-source library that provides tokenization, part-of-speech tagging, and dependency parsing for multiple languages. The language processing module converts character information into a structured representation including tokens, parts of speech, and dependency relations.

The database management system in the server can be a relational database system. The server defines tables for storing utterance records, emotional state records, prompt sentence records, generative AI output records, and feedback records. Each record is associated by identifiers such as child identifiers, user identifiers, and timestamp information.

The terminal executes an application that includes a graphical user interface. The terminal application uses the operating system's audio input interface such as a media recorder interface or audio session interface to capture utterance information as audio information. The terminal uses the operating system's rendering interface to display character information and support information on the display device.

### C. Data Structures and Internal Representations

The server stores utterance information as records that include at least the following fields: a unique utterance identifier, a child identifier, a user identifier, a timestamp, an audio file path, and a transcription status. After speech recognition, the server stores associated character information and updates the record.

The server stores emotional state information as records associated with utterance identifiers. Each emotional state record includes fields such as primary emotion category, secondary emotion categories, emotion intensity, and situation information references. The emotion categories include, for example, categories such as inferiority, anxiety, and self-esteem. The server can represent emotion intensity using a numerical scale such as an integer from 1 to 5.

The server stores situation information such as living-environment information, relationship information, and personal-worry information. The server uses these as contextual attributes that are referenced when generating prompt sentences.

The server stores prompt sentences as text fields associated with utterance records and emotional state records. The server records metadata such as the type of prompt (emotion estimation prompt or support information prompt), generation time, and generative AI model configuration parameters.

The server stores support information as records that include candidate support messages generated by the generative AI model. Each support-information candidate is associated with condition information such as vocabulary limitations and expression limitations used in prompt generation.

The server stores evaluation information and feedback information as records associated with support-information candidates. The feedback processing module refers to these records to adjust internal parameters.

### D. Generative AI Model and Learning Configuration

The generative AI model used in the embodiment is a sequence-to-sequence neural network based on a transformer architecture. The model uses positional encoding to handle word order and uses self-attention mechanisms to capture contextual relationships between tokens within the prompt sentence and between the prompt sentence and generated tokens.

The generative AI model is trained using a loss function such as cross entropy averaged over tokens. The model parameters, including weight matrices for attention, feed-forward layers, and embedding layers, are updated by a gradient-based optimization method such as Adam. The learning process uses mini-batches of training examples and applies regularization techniques such as dropout to prevent overfitting.

The server can additionally perform fine-tuning of the generative AI model using domain-specific data related to children's speech and counseling scenarios. The server constructs fine-tuning data that pairs prompt sentences with desired support information outputs. The server uses supervised learning to minimize the difference between generated tokens and target tokens for the domain-specific data. This fine-tuning allows the generative AI model to generate support information that more accurately reflects emotional states and situations of children.

The server can also adjust decoding parameters at inference time, such as temperature, top-k sampling, or nucleus sampling thresholds, to control the diversity and determinism of generated support-information candidates. By tuning these parameters, the server enhances consistency and safety of generated outputs.

### E. Emotional State Estimation and Feature Extraction

The server implements an emotional state estimation module that uses both rule-based processing and neural-network-based evaluation. The server first uses the language processing module to tokenize character information and identify expression patterns such as comparison expressions, self-evaluation expressions, and other-evaluation expressions. The server maintains a set of pattern templates and keyword lists, such as “compared to other kids,” “I am no good,” “everyone else,” or “people think that I . . . ,” and uses these templates to detect comparison and evaluation patterns.

The server computes feature values such as frequency of negative self-evaluations, presence of comparison-related phrases, and presence of words indicating worry or anxiety. The server uses these feature values as inputs to a classifier implemented as a shallow neural network or a tree-based model stored in the emotional state estimation module. The classifier outputs a probability distribution over emotion categories such as inferiority, anxiety, and self-esteem. The server selects one or more categories having probabilities higher than a threshold as the emotional category information.

By combining rule-based extraction and model-based classification, the server reduces noise and spurious interpretations that might occur if the generative AI model alone were responsible for emotion estimation. Accordingly, the server provides a structured, machine-readable emotional state representation that can be used to construct precise prompt sentences.

### F. Prompt Sentence Generation and Conditioning

The server uses the prompt sentence generation module to automatically construct a prompt sentence for the generative AI model based on emotional state information and situation information. The server uses a template-based generator that concatenates fixed instruction segments with variable segments populated by emotional state information and situation information.

An example of an emotion-estimation prompt sentence is as follows:
“A child said: ‘Compared to the other kids, I'm no good.’
Analyze this utterance.
1. Estimate the child's emotions (for example, sadness, anxiety, inferiority, loss of confidence) and rate their intensity from 1 to 5.
2. Infer possible background factors related to living environment, relationships with friends, and personal worries.
3. Return your answer in a concise explanation.”

An example of a support-information prompt sentence is as follows:
“A child strongly feels inferiority and sadness because they constantly compare themselves to classmates and think, ‘I'm no good.’
Generate 3 short, gentle encouragement messages that a parent can say to this child.
Conditions:
   Use simple language for an elementary school student.
   Avoid criticizing or denying the child's feelings.
   Encourage the child's effort and uniqueness.”

The server can embed additional condition information for vocabulary limitations and expression limitations. For example, the server may insert conditions such as “Use words that an 8-year-old can understand,” or “Do not exceed two sentences per message.” By explicitly representing such conditions in the prompt sentence, the server technically improves control over the generative AI model's output and reduces the need for post-processing.

The prompt sentence generation module uses data structures linking developmental stage categories to vocabulary-level constraints. The server references these structures to populate condition segments in the prompt sentence, which leads to a more deterministic behavior of the generative AI model and reduces variance in outputs.

### G. Feedback-Driven Adaptation and Technical Effects

The server uses the feedback processing module to incorporate evaluation information and feedback information from the user into internal processing. The user, via the terminal, can label support-information candidates as helpful or not helpful, select certain messages for use, or edit messages before using them. The server records these actions as feedback information.

The server analyzes feedback information to compute performance metrics for different types of prompt sentence templates, emotional category mappings, and generative AI parameter settings. For example, the server can measure how often certain templates lead to highly rated support-information candidates. Based on such metrics, the server gradually adjusts internal weight parameters for selecting templates, modifying condition information, or choosing sampling parameters for the generative AI model.

This feedback-driven adaptation improves precision of emotional state estimation and increases the probability that generated support information will be actually used by users. From a technical perspective, the server reduces unnecessary network communication and computation by learning which types of prompt sentences and model configurations yield acceptable results with fewer regeneration cycles. As a result, the server improves processing efficiency, reduces communication load, and enhances quality of service.

In addition, by structuring emotional state information and situation information in machine-readable form and by automatically constructing context-aware prompt sentences, the server offloads complex conditioning logic from the generative AI model itself. The server, rather than an operator, controls model behavior through systematically generated prompts that are not normally achievable by human operators in real time. This improves consistency and reproducibility of generative responses and constitutes an improvement in the functioning of the computer system.

H. Technical Distinction from Mere Automation of Human Work

The server does not merely automate a human counselor's subjective judgment. The server introduces machine-specific representations, such as feature vectors extracted from expression patterns, emotional category distributions, and structured condition information for developmental stage adaptation, that are not directly accessible or manageable by humans. The server applies non-conventional processing sequences, for example, combining deterministic pattern extraction, statistical emotion classification, and template-conditioned prompt sentence generation to control a generative AI model.

Furthermore, the server uses an internal feedback loop where user feedback quantitatively influences future processing: the server modifies prompt template selection probabilities, threshold values for emotion category selection, and sampling parameters for response generation. These operations implement a self-optimizing computational process that reduces error rates in emotional state estimation and improves the relevance of support information over time. Such improvements reduce repeated calls to the generative AI model and lower computational and communication costs, thereby improving the overall performance of the computing infrastructure.

### I. Alternative Embodiments and Variations

The server can be embodied as a distributed system in which different modules are deployed on different physical machines. For example, a first computing node may perform speech recognition, a second computing node may perform language processing and emotional state estimation, and a third computing node may handle generative AI interactions. The nodes communicate using message queues or remote procedure calls. This distributed configuration can further improve scalability and fault tolerance.

The generative AI model can be hosted as a remote service or as an on-premise model executing on a dedicated accelerator such as a graphics processing unit or a tensor processing unit. In the on-premise case, the server implements the full inference stack, including tokenization, model execution, and detokenization. The server can compress model weights, quantize parameters, or apply pruning to improve inference speed and reduce memory usage.

The server can additionally integrate a safety filter model that is a smaller neural network trained to detect inappropriate or harmful content in generated support-information candidates. The server applies the safety filter before presenting support information to the user. If a candidate is flagged, the server can automatically regenerate a new candidate by adjusting the prompt sentence or sampling parameters.

The terminal can be replaced by a variety of computing devices, such as a stationary information terminal in a school, a wearable device with an audio input function, or a home assistant device. In such cases, the terminal still captures utterance information and displays or outputs support information, and the server processing remains substantially the same.

The described embodiment enables the server to transform unstructured utterance information into structured emotional and situational representations, to generate prompt sentences that precisely condition a generative AI model, and to adapt processing based on user feedback. These operations improve the technical functioning of the computer system by enhancing processing speed and accuracy of emotional analysis and by optimizing data flow and communication with the generative AI model, thereby achieving technical effects that go beyond mere automation of human counseling tasks.

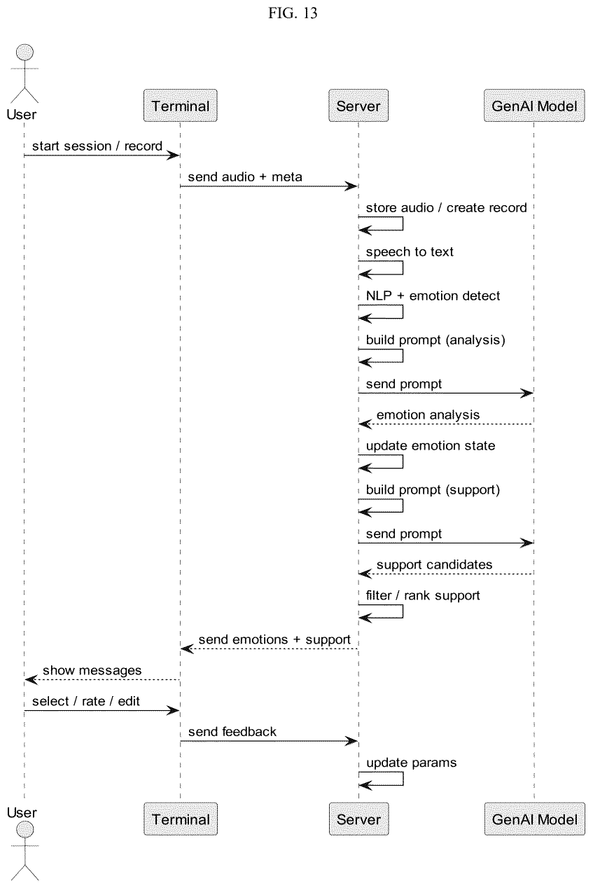

The following describes the processing flow using FIG. 13.

### Step 1:

The user operates the terminal to start an interaction session and initiates a recording or text-input mode.

The terminal receives, as input, an explicit operation from the user (for example, tapping a “Start recording” or “Input text” button) and a child identifier selected on the screen.

The terminal outputs a session context including the child identifier, a session identifier, and an input mode flag to its internal application logic, thereby preparing buffers and user-interface components for subsequent data capture.

### Step 2:

The terminal captures utterance information from the child as audio information using a built-in microphone.

The terminal receives, as input, acoustic signals representing the child's voice and converts the analog signals into digital audio samples using an audio driver.

The terminal performs data processing including sampling, quantization, and audio encoding (for example, into a waveform or a compressed audio format), and outputs a digital audio file together with metadata such as sampling rate, duration, and a local timestamp.

### Step 3:

The terminal transmits the captured audio file and metadata to the server via a network.

The terminal receives, as input, the digital audio file and session context generated in Step 2.

The terminal performs data packaging by constructing a structured request body including a child identifier, a user identifier, a session identifier, and the audio payload, and then sends this packaged data to the server through a secure communication protocol, outputting an HTTP or HTTPS request addressed to an application programming interface of the server.

### Step 4:

The server accepts the incoming request and stores the audio information in a storage subsystem.

The server receives, as input, the HTTP or HTTPS request containing the audio payload and associated metadata.

The server performs request parsing, authentication checking, and data validation, extracts the audio payload, and writes the audio file to a storage device, generating a unique audio file identifier. The server outputs a new utterance record in a database, including the audio file identifier, child identifier, user identifier, and a status field set to indicate that transcription is pending.

### Step 5:

The server performs speech recognition to convert the audio information into character information.

The server receives, as input, the audio file identifier and retrieves the corresponding audio data from storage.

The server processes the audio by applying pre-processing such as normalization and noise reduction, computes acoustic feature vectors, and sends these features to a speech recognition engine. The server receives recognized text from the engine and outputs character information that represents the child's utterance, updating the utterance record to store the text and to set the status to indicate that transcription is completed.

### Step 6:

The server executes natural language processing on the character information to extract linguistic features and expression patterns.

The server receives, as input, the character information stored in the utterance record.

The server performs tokenization, part-of-speech tagging, and dependency parsing using a language processing library, identifies expression patterns including comparison expressions, self-evaluation expressions, and other-evaluation expressions by matching tokens against pattern templates and keyword lists, and outputs an intermediate linguistic representation that includes tokens, tags, dependency relations, and extracted pattern flags.

### Step 7:

The server estimates emotional state information for the child based on the extracted linguistic features.

The server receives, as input, the intermediate linguistic representation from Step 6.

The server computes numerical features such as counts of negative self-evaluations, presence or absence of comparison phrases, and co-occurrence of anxiety-related terms, and applies these features to a trained classifier. The server performs a data computation in which the classifier outputs probability values for emotion categories such as inferiority, anxiety, and self-esteem, and the server selects categories that exceed thresholds. The server outputs emotional state information including emotion categories, intensity scores, and links to situation information, and stores this emotional state information in an emotional state record associated with the utterance.

### Step 8:

The server generates a first prompt sentence for analyzing or confirming the emotional state using a generative AI model, when such analysis is required.

The server receives, as input, the character information and the emotional state information generated in Step 7.

The server performs string assembly and template-based insertion, in which the server inserts the child's utterance, the detected expression patterns, and requests for analysis into a structured textual instruction. The server outputs a prompt sentence that instructs the generative AI model to analyze emotions and possible causes. For example, the server can output a prompt sentence such as:
“A child said: ‘Compared to the other kids, I'm no good.’
Analyze this utterance.
1. Estimate the child's emotions (for example, sadness, anxiety, inferiority, loss of confidence) and rate their intensity from 1 to 5.
2. Infer possible background factors related to living environment, relationships with friends, and personal worries.
3. Return your answer in a concise explanation.”

### Step 9:

The server refines or confirms the emotional state information by sending the first prompt sentence to the generative AI model and integrating the response.

The server receives, as input, the prompt sentence generated in Step 8 and current emotional state information.

The server transmits the prompt sentence to the generative AI model via a generative AI interface, receives a textual analysis output that describes inferred emotions and background factors, and parses this output to extract emotion-related terms and intensity indications. The server performs a data fusion operation that adjusts or augments the existing emotional state information using the generative AI output and outputs an updated emotional state record with refined categories, intensities, and associated situation information.

### Step 10:

The server constructs a second prompt sentence for generating support information tailored to the refined emotional state and situation.

The server receives, as input, the refined emotional state information and associated situation information such as living-environment information, relationship information, and personal-worry information.

The server performs template-driven text generation, in which the server embeds the emotional categories (for example, strong inferiority and sadness), intensity levels, and contextual attributes into instruction segments, and appends condition information specifying vocabulary limitations and expression limitations according to the developmental stage of the child. The server outputs a support-generation prompt sentence. For example, the server can output a prompt sentence such as:
“A child strongly feels inferiority and sadness because they constantly compare themselves to classmates and think, ‘I'm no good.’
Generate 3 short, gentle encouragement messages that a parent can say to this child.
Conditions:
   Use simple language for an elementary school student.
   Avoid criticizing or denying the child's feelings.
   Encourage the child's effort and uniqueness.”

### Step 11:

The server interacts with the generative AI model to obtain multiple support-information candidates based on the second prompt sentence.

The server receives, as input, the second prompt sentence with embedded condition information.

The server sends this prompt sentence to the generative AI model, along with configuration parameters such as a maximum token length and a sampling temperature, and receives as output a set of generated messages. The server parses the output into discrete support-information candidates, each candidate being a separate message, and outputs a list of candidate messages associated with the emotional state record.

### Step 12:

The server filters and ranks the generated support-information candidates to select suitable messages for presentation.

The server receives, as input, the list of support-information candidates from Step 11.

The server applies rule-based filters and, optionally, a safety classification model to detect and remove candidates that violate safety or appropriateness criteria, such as containing harmful or judgmental phrasing. The server computes relevance scores for each remaining candidate using metrics such as alignment with specified emotion categories, compliance with vocabulary limitations, and message length. The server outputs a ranked subset of support-information candidates, storing them as support information linked to the original utterance.

### Step 13:

The server sends the selected support information and the refined emotional state information to the terminal for presentation to the user.

The server receives, as input, the ranked subset of support-information candidates and the corresponding emotional state record.

The server formats these data into a structured response containing the original child utterance, emotional categories and intensity, and selected support messages, and transmits this response to the terminal via the communication module. The server outputs an application-level response that the terminal can parse and render in its user interface.

### Step 14:

The terminal presents the emotional state and support information to the user through a graphical user interface.

The terminal receives, as input, the structured response from the server containing the child's utterance, emotional state information, and support-information candidates.

The terminal performs user-interface rendering processing, in which the terminal displays the utterance, emotion labels, intensity indicators, and multiple candidate messages. The terminal optionally provides control elements that allow the user to select, rate, or edit messages. The terminal outputs a visual and, if desired, auditory presentation of the support information to the user.

### Step 15:

The user reviews the presented information and selects, edits, or evaluates one or more support-information candidates.

The user receives, as input, the displayed emotional state description and candidate messages on the terminal.

The user performs actions such as selecting a preferred message, editing the text to adjust wording, or rating the usefulness of each candidate. The user's operations generate evaluation information and feedback information, and the user outputs these data to the terminal by confirming or submitting the changes and ratings.

### Step 16:

The terminal collects the evaluation information and feedback information from the user and transmits them to the server.

The terminal receives, as input, the user's selection, edited text, and ratings associated with specific support-information candidates.

The terminal composes a feedback payload that includes identifiers of the original utterance, emotional state, and support candidates, together with the user's evaluation metrics and edited content. The terminal sends this payload to the server as a feedback request, outputting structured feedback data for subsequent adaptive processing.

### Step 17:

The server updates internal records and adjusts processing parameters based on the feedback information.

The server receives, as input, the feedback payload from the terminal.

The server writes the feedback information into feedback records linked to the corresponding support-information candidates and emotional state records. The server then performs statistical analysis or parameter updates, for example by increasing selection weights for prompt templates and generative AI settings that produced highly rated messages and decreasing weights for less successful configurations. The server outputs updated model configuration parameters, threshold values, or template selection probabilities, which are stored for use in future generation of prompt sentences and emotional state estimations.

### Step 18:

The server improves subsequent processing of utterance information by using the updated parameters and learned patterns from feedback.

The server receives, as input, the updated configuration and statistical summaries from Step 17.

The server incorporates these updates into later runs of the emotional state estimation module, prompt sentence generation module, and generative AI interface module, thereby adjusting emotion-category thresholds, prompt templates, and generative model parameters. The server outputs refined behavior in the form of faster convergence to acceptable support-information candidates, reduced need for regeneration, and higher alignment between generated support information and user expectations in subsequent sessions.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information processing systems that use artificial intelligence to generate text documents or counseling responses typically treat user input as a static, context-free string. Such systems often require the user to manually provide all necessary attributes and procedural details, and they construct prompts for a generative AI model in an ad hoc manner. As a result, these systems suffer from several technical limitations.

First, the systems do not systematically integrate heterogeneous data sources—such as user attribute records, service-identification metadata, and natural-language emotional cues—into a unified representation suitable for prompt construction. This leads to prompts that are incomplete, noisy, or poorly structured, which in turn degrades the quality and consistency of outputs generated by the AI model. From a computing standpoint, the prompt-generation pipeline is not explicitly modeled as a set of machine-executable transformations on structured feature data, and therefore cannot be optimized or reliably reused across different tasks.

Second, existing architectures typically decouple emotion analysis from downstream document generation. Emotion-analysis components may label a text as “negative” or “positive,” but such labels are not formally bound into the input interface of the generative AI model. Consequently, the model cannot reliably adapt its generation behavior (for example, tone, level of detail, or structure of a document) to the user's emotional state or situational context. This yields responses that are technically correct but contextually inappropriate, and forces additional post-processing or manual editing on client-side devices.

Third, conventional systems lack a robust mechanism for dynamically supplementing user input with additional information obtained from back-end storage systems, such as communication-service identifiers or information-search identifiers associated with the user. Without such automated information completion, the server must either request redundant input from the user, increasing latency and interaction cost, or proceed with under-specified prompts, reducing accuracy and utility of the generated results. This represents an inefficient use of server resources and network bandwidth, as multiple round-trips are required to resolve missing context.

Fourth, many document-generation workflows—such as address-change notification creation—are not integrated with server-side authentication control at the level of AI-generation orchestration. Authentication may be handled at the session layer, but the generative process itself is not gated or parameterized by explicit authentication states. This can lead to unnecessary or unauthorized generation of sensitive documents, and it complicates enforcement of security policies within distributed computing environments.

Accordingly, there is a need for an improved computer-based system and method that (i) systematically acquires and fuses natural-language input, emotional and situational feature data, and back-end attribute information; (ii) automatically constructs prompt sentences for a generative AI model based on this fused state; (iii) uses the generative AI model to produce context-aware responses, advice messages, or procedural documents; and (iv) coordinates these operations under explicit server-side authentication and control logic. Such a system should improve the efficiency, robustness, and contextual accuracy of AI-assisted document creation and counseling support, thereby enhancing the overall functioning of the computing system itself.

The specific processing by the specific processing unit 290 of the data processing device 12 in Application Example 2 is realized by the following means.

The present invention provides a server comprising a processor configured to receive, via an input/output interface, natural-language voice input or text input from a user; to convert, when voice input is received, corresponding voice data into character data by executing speech-recognition processing, or to use character data directly received as input information to be analyzed; to analyze the input information using natural-language processing or emotion-analysis processing so as to extract emotional state information and situational information and to generate emotion-related feature data; to obtain, from a storage device in which additional information is stored in association with communication-service identification information or information-search identification information, additional information corresponding to attribute information or procedure information of the user; to automatically generate, on the basis of the emotion-related feature data, the emotional state information, the situational information, and the additional information, a structured prompt sentence to be supplied to a generative artificial intelligence model; to input the structured prompt sentence to the generative artificial intelligence model and thereby acquire a generated result comprising at least one of a response sentence, an advice sentence, and document data; and to control provision of the generated result to a user terminal via a display device or a voice output device, based on an authentication state obtained by executing user authentication processing using an authentication infrastructure or an external authentication protocol. This enables the server to implement a technically improved pipeline that transforms heterogeneous input signals into a unified feature representation, constructs optimized prompt sentences for a generative AI model in a reproducible and machine-controllable manner, dynamically supplements missing contextual information from back-end storage, and gates AI-based generation and presentation of context-aware responses or procedural documents under explicit authentication control, thereby enhancing the efficiency, reliability, and contextual appropriateness of AI-driven processing within the computing system.

The term “system” refers to an information processing arrangement including at least one server device, one or more terminal devices, and one or more storage devices, which cooperate to execute the claimed processing by operation of a processor.

The term “processor” refers to one or more hardware processing circuits, such as a central processing unit, a graphics processing unit, a digital signal processor, or a combination thereof, capable of executing machine-readable instructions to perform the claimed functions.

The term “input/output interface” refers to a hardware and software interface configured to exchange data between the processor and external entities, including user-operated devices, and may include network interfaces, graphical user interfaces, audio interfaces, and application programming interfaces.

The term “user” refers to a human operator who provides input information to the system, such as natural-language voice or text, and who receives responses, advice, or documents generated by the system.

The term “natural-language voice input” refers to acoustic signals representing spoken utterances in a human language, captured by a sound input device and provided to the processor for analysis.

The term “text input” refers to character-based information representing natural-language content, such as sentences or phrases, provided to the processor through a graphical user interface, application interface, or other data entry mechanism.

The term “voice data” refers to digital data obtained by sampling and encoding an acoustic signal corresponding to a user's speech, suitable for processing by a speech-recognition engine.

The term “character data” refers to digital data representing symbols or characters of a written language, such as encoded text strings that can be processed by natural-language processing algorithms.

The term “input information” refers to data obtained from the user, including at least one of natural-language voice input and text input, which serves as the basis for analysis, prompt-sentence generation, and generative model processing.

The term “speech recognition processing” refers to a computational procedure that converts voice data into corresponding character data by identifying linguistic units such as words or phonemes in the acoustic signal.

The term “natural-language processing” refers to a set of computational techniques for analyzing and interpreting text data in a human language, including but not limited to tokenization, part-of-speech tagging, syntactic parsing, semantic analysis, and sentiment analysis.

The term “emotion-analysis processing” refers to a computational procedure that estimates emotional or affective states from input information, such as text or voice data, by deriving features indicative of emotions like happiness, sadness, anger, or anxiety.

The term “emotional state information” refers to data representing an inferred or estimated emotional condition of the user, such as a label or numerical score indicating a particular emotion and its intensity.

The term “situational information” refers to data representing a contextual state or circumstance related to the user or the user's input, such as a topic, event, task type, or domain of a described problem or procedure.

The term “emotion-related feature data” refers to structured data derived from emotion-analysis processing and natural-language processing, representing one or more quantitative or qualitative features that characterize an emotional state or attitude conveyed in the input information.

The term “attribute information” refers to data identifying characteristics of the user or the user's account, such as profile information, historical usage information, or service-related identifiers, which can be used to supplement or contextualize prompt sentences.

The term “procedure information” refers to data describing a specific operational or administrative task requested by the user, such as a change of address, registration update, or other procedural action to be reflected in a generated document or response.

The term “storage device” refers to any non-transitory computer-readable medium or memory apparatus, such as a magnetic disk, solid-state drive, or database system, configured to store data including additional information associated with identifiers.

The term “communication-service identification information” refers to data that uniquely or semi-uniquely identifies a communication service, account, or application associated with the user, and that can be used as a key to retrieve additional information from a storage device.

The term “information-search identification information” refers to data that identifies an information-search tool, query context, or related account, which can be used to access or correlate stored information relevant to the user's request.

The term “additional information” refers to data stored in association with communication-service identification information or information-search identification information, such as historical records, profile attributes, or configuration parameters, which can be inserted into or referenced by a prompt sentence.

The term “prompt sentence” refers to one or more machine-readable natural-language expressions generated by the processor, formatted to instruct a generative artificial intelligence model to perform a specific generation task under predefined constraints and context.

The term “structured prompt sentence” refers to a prompt sentence whose content and layout are determined according to a predefined scheme or template, incorporating distinct segments for context, constraints, and instructions in order to guide the generative artificial intelligence model in a reproducible manner.

The term “generative artificial intelligence model” refers to a trained machine-learning model, such as a large-scale language model, that receives a prompt sentence as input and outputs generated content, including text or document data, based on learned statistical patterns.

The term “generated result” refers to data produced by the generative artificial intelligence model in response to a prompt sentence, including at least one of a response sentence, an advice sentence, and structured or unstructured document data.

The term “response sentence” refers to a natural-language sentence or group of sentences generated to directly answer, react to, or converse with a user based on the user's input information and context.

The term “advice sentence” refers to a natural-language sentence or group of sentences containing guidance, recommendations, or suggestions tailored to the user's emotional state, situational information, or procedural needs.

The term “document data” refers to generated content that forms all or part of a structured document, such as a notification letter, application form, or other textual artifact intended for formal or administrative use.

The term “address-change notification document” refers to a type of procedural document data that informs a receiving entity of a change in the user's address and may include the user's previous address, new address, and relevant dates.

The term “user terminal” refers to a computing device operated by the user, such as a smartphone, tablet, or personal computer, which is configured to transmit input information to the server and to present generated results through a display or audio output device.

The term “display device” refers to any output apparatus capable of visually presenting text or graphics to the user, such as a liquid crystal display, organic light-emitting diode display, or other screen associated with a user terminal.

The term “voice output device” refers to any apparatus capable of producing audible sound based on digital audio data, such as a loudspeaker, earphone, or headset associated with a user terminal.

The term “authentication infrastructure” refers to a set of hardware and software components implementing an authentication framework, such as a public-key infrastructure or centralized identity management system, used to verify the identity of a user.

The term “external authentication protocol” refers to a standardized communication protocol used to perform user authentication via an external service or identity provider, such as a token-based or authorization-code-based protocol.

The term “user authentication processing” refers to a sequence of computational steps executed by the processor to verify the identity or access rights of a user, using one or more authentication infrastructures or external authentication protocols.

The term “authentication state” refers to information indicating a result or current status of user authentication processing, such as whether the user is authenticated, the level of assurance, or the scope of authorized operations.

In one embodiment, a server executes a program on a processor to implement the claimed system. The server includes at least one central processing unit (CPU), at least one graphics processing unit (GPU), a main memory, a non-transitory storage device, and a network interface. The server operates under an operating system such as a general-purpose server operating system, and executes application programs written, for example, in a high-level language. The server communicates with one or more terminals via a wired or wireless network, and the terminals include user devices such as smartphones, tablet computers, or personal computers having a display device, a voice input device, and a voice output device.

The server stores, in the storage device, executable modules including a voice-processing module, a natural-language processing module, an emotion-analysis module, a prompt-generation module, a generative artificial intelligence model interface module, an authentication module, and a result-presentation control module. The server further stores data structures including user attribute records, procedure records, communication-service identification information, information-search identification information, and logs of past generated results. The storage device may be implemented as a relational database management system or a key-value store.

The terminal acquires natural-language voice input from the user by means of a microphone and converts the acoustic signal into digital voice data. The terminal may perform pre-processing such as noise reduction, sampling at a predetermined sampling rate, and encoding in a predetermined audio format. Alternatively, the terminal acquires text input from the user via a graphical user interface, and transmits the text over a network to the server. The user may input procedure information such as information regarding a change of address, or may input narrative content expressing emotional concerns or situational descriptions.

The server processes voice data by invoking the voice-processing module, which controls a speech-recognition engine. The server can employ a statistical or neural-network-based speech recognizer, such as a recurrent neural network or a transformer-based acoustic model, to convert sequences of acoustic feature vectors into sequences of text tokens. The server computes acoustic features such as Mel-frequency cepstral coefficients, log-mel filterbank energies, or other spectral features from the voice data. The server then decodes the most likely sequence of words by applying a trained model and a decoding algorithm such as beam search. The server outputs character data representing the recognized words.

The server processes character data, whether obtained directly from the terminal or generated by speech recognition, by invoking the natural-language processing module. The server segments text into tokens, applies part-of-speech tagging, and computes embeddings for the tokens using an embedding model such as word embeddings or contextual embeddings generated by a transformer-based encoder. The server passes the embeddings to the emotion-analysis module.

The server implements the emotion-analysis module as a trained neural network or a combined rule-based and neural model. For example, the server may use a bidirectional recurrent neural network, a convolutional network, or a transformer encoder over the sequence of token embeddings. The server defines an output layer that produces, for each input sequence, a set of emotion probabilities over predefined categories such as sadness, happiness, anger, anxiety, and neutrality, and one or more continuous sentiment scores. The server computes an emotion-related feature vector that includes the probabilities, sentiment scores, and contextual indicators such as topic labels or domain tags. The server may further integrate information from voice prosody, when available, by extracting pitch, energy, and speaking rate features from the voice data and providing these features as additional inputs to the emotion-analysis model.

The server obtains attribute information and procedure information from the storage device. The server searches user attribute records using identifiers such as communication-service identification information or information-search identification information. The server retrieves stored data such as user name, historical address records, service types, and prior procedure history. The server selects a subset of such data that is relevant to the current input information. For instance, when the procedure information indicates a change of address, the server retrieves the most recent confirmed address data and any reference templates associated with address-change notifications.

The server generates a prompt sentence using the prompt-generation module. The server constructs the prompt sentence as a structured natural-language string that incorporates, in predefined segments, the input information, the emotion-related feature data, and the additional information. The server may adopt a template-based scheme in which the prompt sentence comprises an instruction segment, a context segment, and a constraint segment. For example, the server can construct an instruction segment such as:
“You are an assistant that generates formal notification documents.”

The server can construct a context segment that incorporates procedure and attribute information such as:
“Generate a formal address change notification letter with the following information: Name: [user name], Old address: [old address], New address: [new address].”

The server can add a constraint segment specifying tone or length, for example:
“Use a polite tone suitable for official correspondence and limit the letter to one page.”

The server concatenates these segments into a single prompt sentence to be provided to the generative AI model.

The server, in another example, constructs a prompt sentence for an emotionally responsive message as follows:
“A child said: ‘I don't want to go to school.’ Sentiment: strongly negative, topic: school. As a child psychology assistant, explain in one or two sentences what emotional state this child might be in.”

The server may then construct a further prompt sentence for an encouragement message:
“A child feels anxious and overwhelmed about school and says, ‘I don't want to go to school.’ Generate a short, warm encouraging message directly to the child in simple language. Limit to 2 sentences.”

The server supplies the generated prompt sentence to the generative AI model via the generative AI model interface module. The server may implement the generative AI model as a large-scale neural language model deployed on the server or accessed through a network service. The model may have a transformer architecture composed of multiple self-attention layers, feed-forward sublayers, and normalization layers. The server represents the prompt sentence as a sequence of tokens and maps the tokens to embeddings. The server feeds the embeddings to the transformer network, which computes contextualized hidden representations and outputs probability distributions over a vocabulary at each time step. The server generates output tokens by sampling or selecting tokens based on the distributions according to a decoding strategy, such as greedy decoding or beam search, with parameters controlling diversity, such as temperature or top-k sampling.

The server may train or fine-tune the generative AI model on a training corpus that includes examples of procedural documents, notification letters, counseling dialogues, and advisory messages. The server uses a loss function such as cross-entropy between predicted token distributions and target tokens, and updates model parameters by gradient descent or a variant thereof, such as Adam optimization. The server may apply regularization techniques including dropout or weight decay, and may perform data augmentation such as paraphrasing, synonym substitution, or controlled template variations to improve robustness.

The server acquires a generated result from the generative AI model. When the prompt sentence requests a procedural document, the server obtains document data that includes one or more paragraphs forming an address-change notification document or a similar procedural document. When the prompt sentence requests an emotionally appropriate advice or response, the server obtains one or more sentences that form a response sentence or an advice sentence. The server may perform post-processing such as checking for prohibited content, normalizing formatting, or inserting user-specific placeholders.

The server executes an authentication module prior to presenting generated results in certain use cases. The server interacts with an authentication infrastructure or an external authentication protocol to authenticate the user. The server may redirect the terminal to an identity provider and receive an authentication token, or may verify credentials against a directory service. The server stores an authentication state in session data, and determines whether the user is authorized to receive a given type of document data. The server controls the result-presentation control module such that only authenticated users receive generated documents related to sensitive procedures, such as address-change notifications.

The terminal presents generated results received from the server to the user. The terminal renders text-based document data or advice sentences on a display device. The terminal may also receive audio data generated by a text-to-speech module, executed either on the server or on the terminal, and output the audio via a voice output device. The terminal may provide user-interface controls that allow the user to confirm, edit, or store the generated document.

The server, by implementing the above modules and data structures, improves computer technology in several ways. The server does not simply automate human drafting or counseling. Instead, the server introduces a specific pipeline that converts heterogeneous input signals (voice, text, meta-identifiers) into structured feature vectors, integrates those features with back-end stored attributes, and then generates structured prompt sentences. By explicitly modeling the prompt-generation process as an algorithmic transformation on machine-readable feature data, the server reduces ambiguity in prompts, reduces the number of iterations required to obtain acceptable AI outputs, and reduces network traffic between the server and the generative AI model service.

The server improves processing speed and resource efficiency by reusing intermediate feature representations and by caching emotion-related feature data and attribute information. For example, the server can maintain a cache of emotion-related feature vectors keyed by recent user utterances, and a cache of frequently used attribute combinations, thereby avoiding redundant computation and database queries. The server also reduces communication overhead by constructing prompt sentences locally on the server, rather than sending raw historical data or large unstructured logs to the generative AI model.

The server improves accuracy and contextual appropriateness of generated documents and advice. The emotion-analysis module provides fine-grained emotional state information, which the prompt-generation module incorporates into the instruction and constraint segments of the prompt sentence. As a result, the generative AI model receives explicit guidance about emotional tone, level of formality, and target audience, which leads to more reliable and consistent outputs. The server further incorporates procedure information and attribute information into the prompt sentence, which reduces omissions and errors in generated procedural documents, such as address-change notification letters.

The server employs specific neural architectures and learning methods in the emotion-analysis module and the generative AI model that differ from conventional rule-based or purely manual systems. The emotion-analysis module uses learned weights and activation functions to map high-dimensional embedding sequences into emotion-related feature vectors, following a non-linear mapping that cannot be reproduced by simple linear scoring rules. The generative AI model uses multi-head attention mechanisms to capture long-range dependencies in the prompt sentence, enabling coherent generation of multi-sentence documents. These structures allow the server to process complex inputs and generate outputs that are difficult to produce with traditional, manually coded templates.

The server can, in alternative embodiments, vary the architecture of the emotion-analysis module. The server may implement a hybrid system in which a rule-based layer filters or re-weights emotion predictions produced by a neural network. The server may also incorporate additional modalities, such as image-based facial-expression features, into the emotion-related feature data. The server can adapt the prompt-generation module to different domains by selecting different templates or constraint patterns based on procedure type or user role.

The server, in another embodiment, can operate in a distributed environment in which the generative AI model runs on a separate computation node or cloud service, and the server acts as an orchestrator that constructs prompt sentences, issues generation requests, and post-processes the generated results. The server may also perform load balancing and parallel processing of multiple user requests, using task queues and worker processes.

The terminal may, in some embodiments, perform part of the natural-language pre-processing or emotion-analysis function using local models, and transmit intermediate feature data rather than raw audio to the server, thereby reducing bandwidth requirements and improving latency. The server may adjust the complexity of downstream processing based on the quality of such pre-computed features.

By defining specific data structures for emotion-related feature data, attribute records, and prompt templates, and by specifying how the server transforms these structures, the system achieves technical effects such as reduced computational complexity for repeated tasks, improved cache locality for feature vectors, and more efficient memory usage in the generative AI model interface. The improved pipeline also reduces errors due to missing context and reduces human intervention in correcting generated results, while still relying on explicit algorithmic control over feature extraction and prompt construction rather than uncontrolled black-box generation.

In summary, the server, the terminal, and the user interact in a manner that applies concrete hardware and software mechanisms—speech recognition engines, natural-language processing libraries, emotion-analysis neural networks, transformer-based generative AI models, structured prompt templates, and authentication protocols—to implement the claimed system. The system achieves technical improvements in processing speed, accuracy, resource utilization, and communication efficiency by organizing these components into a coordinated architecture in which the server algorithmically generates and supplies optimized prompt sentences to a generative AI model and controls presentation of the model's outputs under authenticated conditions.

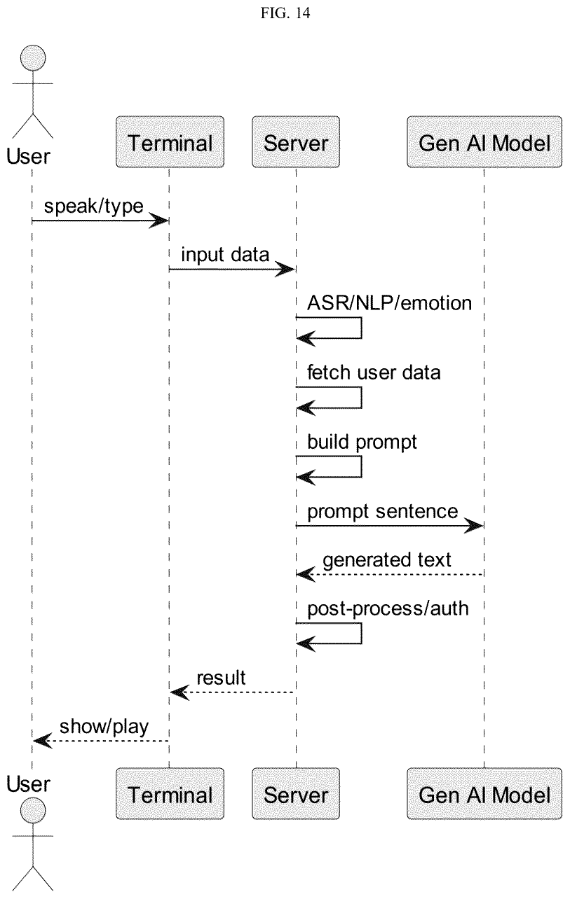

The following describes the processing flow using FIG. 14.

### Step 1:

User provides input to the terminal.

User speaks a natural-language utterance to the terminal or types text into a user interface on the terminal. The input is, for example, a procedural request such as “I want to change my address” or an emotional statement such as “I don't want to go to school.”

Input: Human speech sound waves, or typed characters on the terminal.

Output: Raw audio signal captured by the microphone, or raw text string captured by the user interface.

### Step 2:

Terminal digitizes and packages the input.

Terminal samples the audio signal from the microphone at a predetermined sampling rate and quantization (for example, 16 kHz, 16-bit PCM) and stores the samples in a buffer. Terminal may apply noise reduction and volume normalization. Terminal encodes the buffered samples into an audio container format (for example, WAV) and attaches metadata such as user ID and timestamp. When text is entered, terminal converts keystrokes into a Unicode text string and associates similar metadata.

Input: Raw audio signal or keystrokes from the user.

Output: Digital audio file with metadata, or Unicode text string with metadata, ready to be sent to the server.

### Step 3:

Terminal transmits the packaged input to the server.

Terminal opens a secure network connection (for example, HTTPS) to the server and sends a request message containing the audio file or text string and associated metadata in a structured format. Terminal waits for an acknowledgment from the server.

Input: Audio file or text string plus metadata in the terminal's memory.

Output: Network request containing the packaged input, delivered to the server.

### Step 4:

Server receives and stores the input.

Server accepts the network request, verifies basic integrity (for example, content length and format), and stores the received audio file or text string into a temporary storage area or a database record keyed by a session identifier. Server logs the request for auditing purposes.

Input: Network request with audio file or text string and metadata.

Output: Stored input record containing raw input data and metadata in server storage, plus a session identifier.

### Step 5:

Server performs speech recognition when the input is audio.

Server checks the input type in the stored record. When the input includes audio, server invokes a speech-recognition engine. Server computes acoustic feature vectors (for example, Mel-frequency cepstral coefficients) from the audio samples, feeds the features into a trained acoustic model, and uses a decoding algorithm to infer the most probable sequence of words. Server thereby converts the audio into character data.

Input: Digital audio file with user speech.

Output: Recognized text string corresponding to the speech, stored as character data in association with the session identifier.

### Step 6:

Server prepares text input for analysis.

Server selects either the recognized text (from audio) or the originally transmitted text (when user typed) as unified input information. Server normalizes the text (for example, lowercasing, Unicode normalization) and segments the text into tokens.

Input: Character data representing the user's utterance.

Output: Normalized token sequence and an associated text string ready for natural-language and emotion analysis.

### Step 7:

Server extracts linguistic and emotional features.

Server processes the token sequence using a natural-language processing module and an emotion-analysis module. Server generates token embeddings, applies a sequence model (for example, a transformer encoder or recurrent network), and computes probabilities for emotion categories, sentiment scores, and topic indicators. Server aggregates these values into an emotion-related feature vector and stores it with the session identifier.

Input: Normalized token sequence and text string.

Output: Emotion-related feature vector and derived labels (emotion category, sentiment score, topic), representing emotional state information and situational information.

### Step 8:

Server retrieves attribute and procedure information from storage.

Server examines the text and feature vector to determine whether the input includes procedure information (for example, change of address) or purely counseling content. Server uses communication-service identification information or other identifiers in the metadata to query a storage device such as a database. Server retrieves user attribute information including, for example, previous address records, registered name, and service type. Server filters these records according to the detected procedure type.

Input: Metadata (user identifiers) and emotion-related feature vector, plus stored user attribute records in the database.

Output: Selected attribute information and procedure-related data associated with the current session.

### Step 9:

Server constructs a prompt sentence for the generative AI model.

Server invokes the prompt-generation module and combines the text input, emotion-related feature vector, and retrieved attribute information into a structured natural-language instruction. Server organizes the prompt into segments such as instruction, context, and constraints. For example, server constructs:
“You are an assistant that generates formal notification documents.
Generate a formal address change notification letter with the following information: Name: [user name], Old address: [old address], New address: [new address].
Use a polite tone suitable for official correspondence and limit the letter to one page.”

Or, for an emotional case, server constructs:
“A child said: ‘I don't want to go to school.’ Sentiment: strongly negative, topic: school. As a child psychology assistant, explain in one or two sentences what emotional state this child might be in.”

Input: Text string, emotion-related feature vector, and attribute/procedure data.

Output: Structured prompt sentence ready to be input to the generative AI model.

### Step 10:

Server requests content generation from the generative AI model.

Server encodes the prompt sentence as tokens and sends them to the generative AI model via a model interface. The model processes the tokens using its neural architecture and outputs a sequence of tokens representing generated content. Server decodes the output tokens into a text string, which forms a generated result such as a response sentence, an advice sentence, or document data.

Input: Prompt sentence for the generative AI model.

Output: Generated text content (for example, a notification document or an advice message) associated with the session identifier.

### Step 11:

Server optionally refines and formats the generated result.

Server applies post-processing rules to the generated text, such as checking for prohibited terms, correcting simple formatting issues, or inserting fixed headers or footers for documents. When the result is a procedural document, server may merge the generated body text with a predefined document template. When the result is advice, server may ensure that length and tone match predefined constraints.

Input: Raw generated text from the generative AI model.

Output: Refined text suitable for presentation or for use as completed document data.

### Step 12:

Server enforces authentication and access control.

Server checks the authentication state associated with the session. When the generated result contains sensitive data, such as an address-change notification, server verifies that the user is authenticated via an authentication infrastructure or external authentication protocol. If authentication is not sufficient, server may deny or limit access to the generated result; if authentication is sufficient, server authorizes full presentation.

Input: Refined generated text and authentication state.

Output: Decision on whether and how the generated result may be presented to the terminal (for example, full text, partial text, or error/authorization request).

### Step 13:

Server prepares a response message for the terminal.

Server composes a response object that encapsulates the authorized generated result, including text content and optional metadata such as type of result (document or advice), timestamp, and identifiers. If configured, server may also trigger a text-to-speech module to synthesize audio from the generated text and include a reference or payload for the audio data.

Input: Authorized generated text and optional synthesized audio.

Output: Response message containing the generated content and metadata, ready for network transmission.

### Step 14:

Server transmits the response to the terminal.

Server sends the response message over the secure network connection to the terminal. Server may compress the payload to reduce communication load and sets appropriate headers indicating content type and length.

Input: Response message in server memory.

Output: Network message delivered to the terminal containing generated content.

### Step 15:

Terminal receives and presents the generated result.

Terminal receives the network response from the server and parses the payload. Terminal extracts the generated text and any associated audio. Terminal displays the text on the display device, for example in a document view or chat-style interface, and, when audio is present, sends the audio stream to the voice output device for playback. Terminal may allow the user to scroll through, confirm, or save the document or advice.

Input: Response message with generated text and optional audio.

Output: Visual and/or audible presentation of the generated document or advice to the user.

### Step 16:

User reviews and optionally responds to the presented output.

User reads the generated document or advice message on the terminal and may confirm its correctness, request modifications, or initiate a new interaction. If the user inputs additional text or speech (for example, “Please add the effective date of my address change”), the process returns to the earlier steps with the new input information, allowing iterative refinement using the same pipeline of analysis, prompt-sentence construction, and generation.

Input: Presented generated content and user's follow-up interaction.

Output: New raw input that can be processed again by the system, enabling iterative improvement or completion of the document or counseling output.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

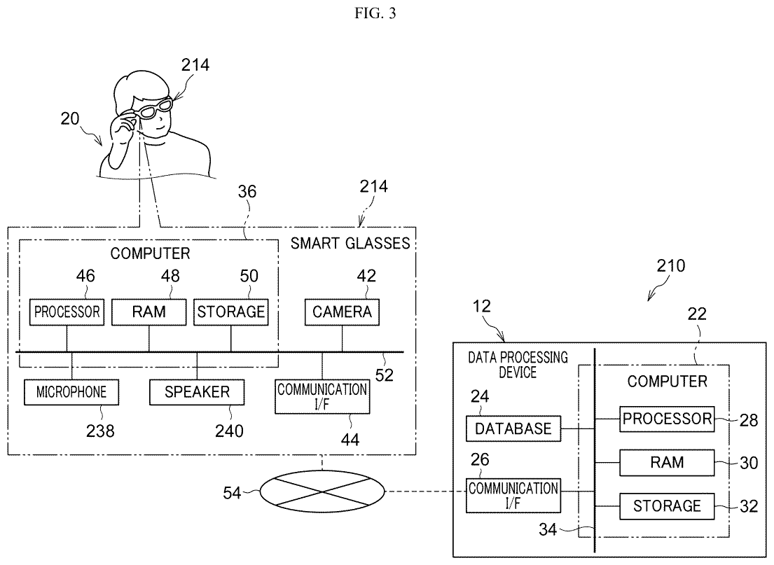

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

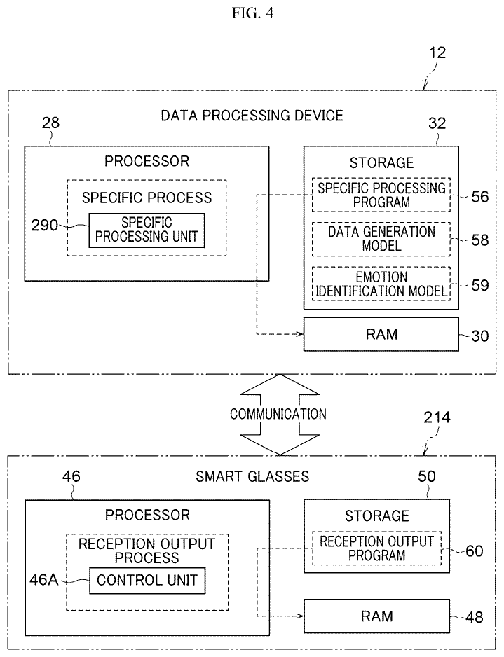

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

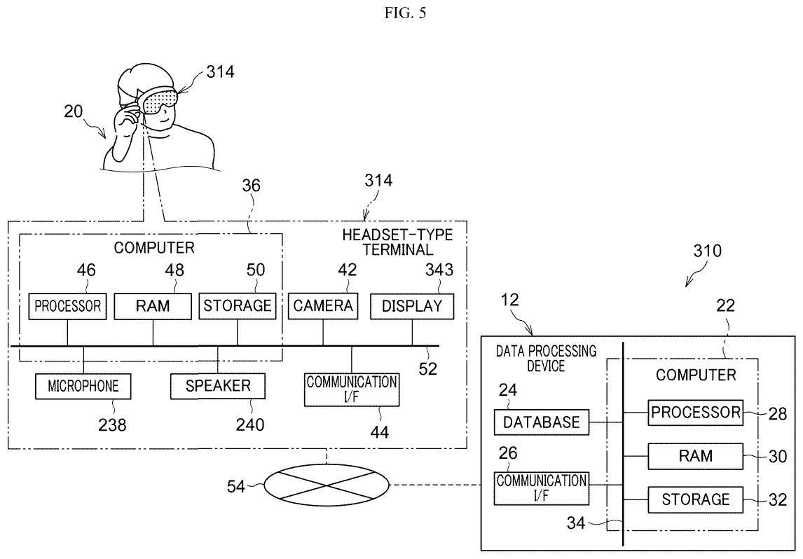

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

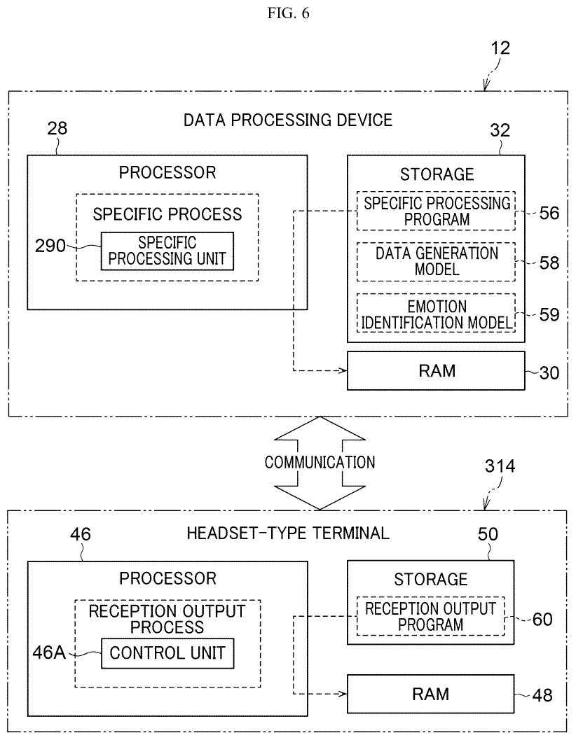

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

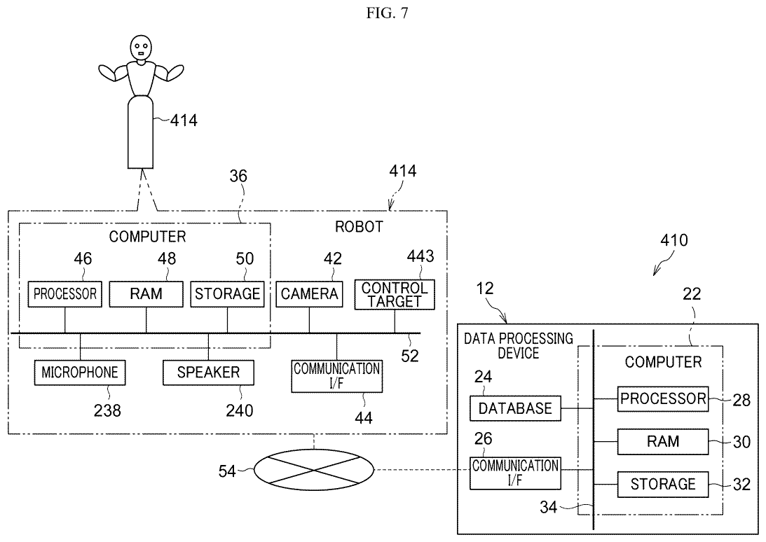

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

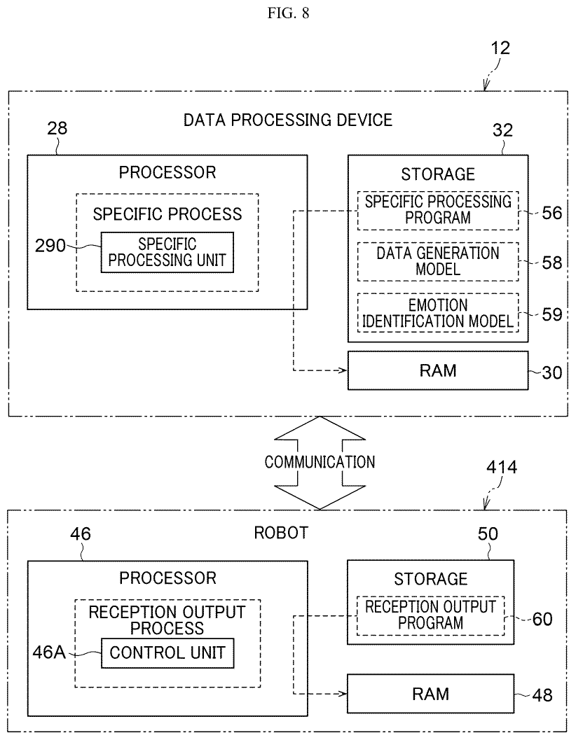

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

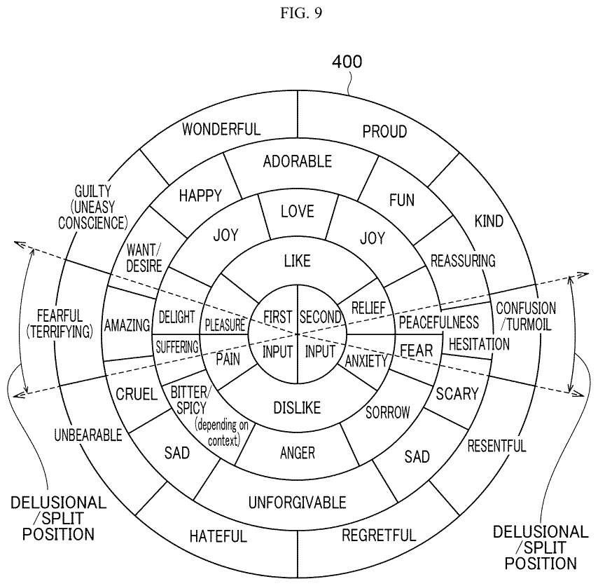

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

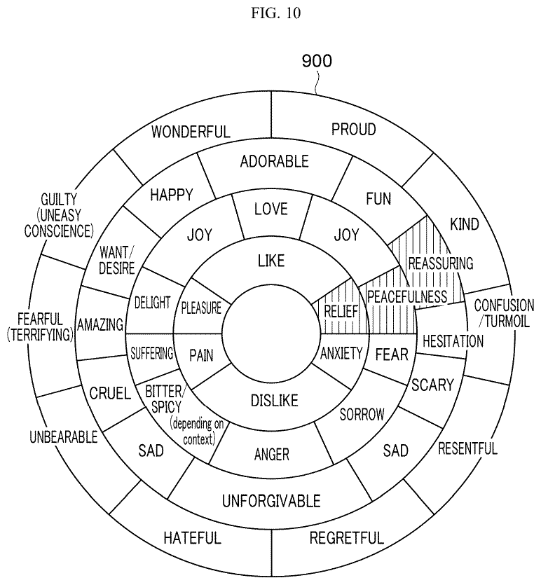

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
provide an input/output interface for acquiring input information from a user and acquiring audio information of a subject,
receive audio data transmitted from a terminal that captures the audio information of the subject, and convert the audio data into character string data by performing speech recognition processing,
perform natural language processing on the character string data to extract emotion information, intention information, and feature word information,
construct a prompt sentence to be input to a generative information processing model based on the character string data and the emotion information, the intention information, and the feature word information,
input the prompt sentence to the generative information processing model and acquire response information from the generative information processing model, the response information including emotional state information of the subject and latent problem information of the subject,
store the response information and a result of the natural language processing, and aggregate the stored information in a time series manner for each subject to generate index information, and
output the response information and the index information as a display screen for the user, to support determination of support policy information by the user.

### (Supplementary 2)

The system according to supplementary 1,
wherein the processor is configured to
embed at least a part of the emotion information and the intention information estimated by the natural language processing into the prompt sentence together with a description that instructs inference of the emotional state of the subject and latent problems in a daily environment or an educational environment.

### (Supplementary 3)

The system according to supplementary 1,
wherein the processor is configured to
calculate score information representing a degree of risk for each subject, based on the stored emotion information and the emotional state information, as the index information, and list the subjects on the display screen in an order of priority according to the score information.

### Application Example 1

### (Supplementary 1)

A system comprising a processor,
wherein the processor is configured to
receive, via an input/output device, audio information or image information provided by a user, the audio information including utterances of a child and the image information including a facial expression or behavior of the child,
execute a conversion process to transform the audio information received via the input/output device into character information that is analyzable as text data,
execute language analysis processing and emotion analysis processing on the character information to extract feature information related to an emotional state or a concern of the child,
generate a prompt sentence for a generative AI model based on the feature information and the character information so as to cause the generative AI model to generate an estimation result of the emotional state or the concern of the child and guidance information for a guardian or an educator, and input the prompt sentence into the generative AI model, and
acquire response information output from the generative AI model, the response information including the estimation result and the guidance information, and execute communication processing to transmit the response information as a notification to a terminal device of the guardian or the educator.

### (Supplementary 2)

The system according to supplementary 1,
wherein the processor is configured to
execute image analysis processing on the image information to extract additional feature information related to the facial expression or the behavior of the child, integrate the additional feature information with the feature information obtained by the language analysis processing and the emotion analysis processing, and generate the prompt sentence based on the integrated feature information.

### (Supplementary 3)

The system according to supplementary 1,
wherein the processor is configured to
acquire response operation information from the guardian or the educator, and update at least one of a structure of the prompt sentence and a representation format of the guidance information output by the generative AI model based on the response operation information.

### Example 2

### (Supplementary 1)

A system comprising a processor,
wherein the processor is configured to
receive, via an information input/output interface, utterance information or character information relating to a child from a user,
convert, by using a speech processing function, audio information included in the utterance information into character information, and perform language processing on the character information to extract emotional state information indicating a mental state and a situation of the child,
generate, on the basis of the emotional state information, a prompt sentence to be input to a generative AI model, and input the prompt sentence to the generative AI model so as to cause the generative AI model to generate support information corresponding to the mental state and the situation of the child, and
present the support information generated by the generative AI model to the user, acquire evaluation information or feedback information from the user with respect to the support information, and reflect the evaluation information or the feedback information in a generation process of the prompt sentence or in a generation process of the emotional state information.

### (Supplementary 2)

The system according to supplementary 1,
wherein the processor is configured to
extract, from the character information, expression patterns including comparison expressions, self-evaluation expressions, and other-evaluation expressions, and specify the emotional state information for the child as emotion category information including at least one of inferiority feeling, anxiety feeling, and self-esteem feeling on the basis of the expression patterns.

### (Supplementary 3)

The system according to supplementary 1,
wherein the processor is configured to
embed, in the prompt sentence, the emotional state information and situation information including at least one of living-environment information, relationship information, and personal-worry information associated with the emotional state information, add condition information including vocabulary limitations and expression limitations according to a developmental stage of the child to the prompt sentence, input the prompt sentence with the condition information to the generative AI model, and cause the generative AI model to generate a plurality of support-information candidates that satisfy the condition information.

### Application Example 2

### (Supplementary 1)

A system comprising a processor,
wherein the processor is configured to
receive, via an input/output interface, natural-language voice input or text input from a user,
convert voice data acquired via the input/output interface into character data by performing speech recognition processing, or use character data directly acquired via the input/output interface as input information to be analyzed,
analyze the input information to extract emotional state information and situational information by executing natural-language processing or emotion-analysis processing and thereby generate emotion-related feature data,
automatically generate a prompt sentence, to be input to a generative artificial intelligence model, on the basis of the emotion-related feature data and the input information,
input the prompt sentence to the generative artificial intelligence model and acquire a generated result comprising a response sentence, an advice sentence, or document data corresponding to the emotional state information and the situational information,
output and present the response sentence or the advice sentence to a user terminal via a display device or a voice output device of the user terminal,
and obtain, from a storage device in which additional information is stored in association with communication-service identification information or information-search identification information, additional information to be included in the prompt sentence on the basis of attribute information or procedure information received from the user, and supply the additional information to the generation of the prompt sentence.

### (Supplementary 2)

The system according to supplementary 1,
wherein the processor is configured to, when the character data acquired as the input information or the character data obtained after the speech recognition processing represents procedure information regarding a change of address by the user, generate, on the basis of an analysis result of the emotional state information and the situational information and on the basis of attribute information supplemented from the storage device, a prompt sentence that instructs creation of an address-change notification document or a similar procedure document, input the prompt sentence to the generative artificial intelligence model, and cause the generative artificial intelligence model to generate body text data of the document.

### (Supplementary 3)

### The System According to Supplementary 1,

wherein the processor is configured to execute user authentication processing based on a public authentication infrastructure or an external authentication protocol, start or control generation processing of the document data or the advice sentence data by the generative artificial intelligence model in accordance with a result of the authentication processing, and permit presentation of the generated result by the display device or the voice output device only to an authenticated user.

What is claimed is:

1. A system comprising:
circuitry configured to:
receive, via a communication interface coupled to a packet-switched network, audio data captured by a terminal device, and convert the audio data into character string data by executing speech recognition processing on the audio data using an acoustic model and a language model to generate a token sequence;
perform natural language processing on the character string data to extract emotion information including probability values over a plurality of emotion categories, intention information including communicative intent classification labels, and feature word information including semantically significant token identifiers;
construct an instruction sequence based on the character string data, the emotion information, the intention information, and the feature word information, the instruction sequence having a structured layout comprising an utterance segment, a feature segment embedding the extracted information, and a directive segment specifying inference constraints;
input the instruction sequence into a generative neural network model comprising a transformer-based architecture with a plurality of self-attention layers to cause the generative neural network model to generate response data including inferred condition data and explanatory segment data;
store the response data and the extracted information in a storage device in association with a subject identifier, and aggregate stored records associated with the subject identifier in a time-series arrangement to compute index data including a risk-oriented score value derived from a scoring function applied to accumulated emotion information and inferred condition data over a temporal window; and
generate display control data presenting a prioritized listing of subject identifiers arranged according to the risk-oriented score values, and transmit the display control data to an operator terminal device via the communication interface.

2. The system according to claim 1, wherein the circuitry is further configured to:
execute the speech recognition processing by computing acoustic feature vectors including Mel-frequency cepstral coefficients from the audio data, inputting the acoustic feature vectors to the acoustic model implemented as a deep neural network, and decoding a most probable word sequence using a beam search algorithm applied to output probabilities of the acoustic model and the language model.

3. The system according to claim 2, wherein the circuitry is further configured to:
normalize the character string data by applying text normalization rules including lowercasing, punctuation restoration, and removal of non-speech tokens, and store the normalized character string data in the storage device in a transcript record linked to the audio data.

4. The system according to claim 3, wherein the circuitry is further configured to:
perform the natural language processing by executing tokenization to divide the character string data into tokens, part-of-speech tagging to assign grammatical categories to each token, and dependency parsing to identify syntactic relations among the tokens, and generate a linguistic feature vector from the tokens, tags, and dependency relations.

5. The system according to claim 4, wherein the circuitry is further configured to:
extract the emotion information by applying the linguistic feature vector to an emotion classification neural network comprising an embedding layer, at least one attention-based layer, and a classification layer that outputs probability values for the plurality of emotion categories, and extract the intention information by applying the linguistic feature vector to a multi-class intent classifier that outputs the communicative intent classification labels.

6. The system according to claim 1, wherein the circuitry is further configured to:
construct the instruction sequence by loading a template structure defining placeholder positions for an utterance field, a sentiment value field, an emotion label field, a feature word field, and a directive field, and populating the placeholder positions with corresponding values extracted from the character string data and the emotion information, the intention information, and the feature word information.

7. The system according to claim 6, wherein:
the generative neural network model comprises a multi-layer self-attention architecture with multi-head attention sublayers, feed-forward sublayers, and layer normalization components, and the circuitry is configured to control decoding of the generative neural network model using inference parameters including a maximum output length, a sampling temperature, and a decoding strategy parameter.

8. The system according to claim 7, wherein the circuitry is further configured to:
parse the response data by detecting structured delimiter markers or keyword markers mandated in the instruction sequence, and extract from the response data at least an inferred condition category, an inferred condition description, and a recommendation segment, and store the extracted fields as machine-readable records in the storage device.

9. The system according to claim 1, wherein the circuitry is further configured to:
compute the risk-oriented score value by calculating an exponentially weighted moving average of negative sentiment scores associated with the subject identifier over the temporal window, counting occurrences of high-intensity emotion categories within the temporal window, and combining the calculated values using a weighted scoring function that assigns differential weights to different indicator types.

10. The system according to claim 9, wherein the circuitry is further configured to:
maintain an inverted index associating subject identifiers with corresponding risk-oriented score values, sort the subject identifiers in descending order of the risk-oriented score values, and generate the display control data including color-coded risk level indicators, expandable detail views, and filter controls based on inferred condition categories.

11. The system according to claim 10, wherein the circuitry is further configured to:
compute trend indicator data for each subject identifier by comparing the risk-oriented score value at a current time point against the risk-oriented score value at a previous time point, and classify the trend as increasing risk, stable risk, or decreasing risk, and include the trend indicator data in the display control data.

12. The system according to claim 1, wherein the circuitry is further configured to:
receive, via the communication interface, image data captured by the terminal device, execute image analysis processing on the image data using a convolutional neural network to extract visual feature data including facial expression likelihood values and posture descriptor values, and integrate the visual feature data with the emotion information and the feature word information into an integrated feature representation for use in constructing the instruction sequence.

13. The system according to claim 12, wherein the circuitry is further configured to:
integrate the visual feature data with the emotion information by normalizing each feature set to a common scale and performing a concatenation operation to create the integrated feature representation, and embed the integrated feature representation in the feature segment of the instruction sequence.

14. The system according to claim 1, wherein the circuitry is further configured to:
acquire, from the operator terminal device via the communication interface, response operation data indicating an evaluation of the response data by an operator, analyze patterns in the response operation data over a plurality of events, and update internal parameters controlling at least one of template selection in the instruction sequence, feature threshold values, and representation formatting of the response data.

15. The system according to claim 14, wherein the circuitry is further configured to:
correlate the response operation data with characteristics of corresponding instruction sequences and response data to compute performance metrics for different template configurations, and adjust the instruction sequence construction to increase usage of template configurations associated with higher-rated response data.

16. The system according to claim 1, wherein the circuitry is further configured to:
analyze application identifier data or tool identifier data associated with the subject identifier to retrieve supplementary attribute data from the storage device, and incorporate the supplementary attribute data into the instruction sequence to complement information not explicitly included in the character string data.

17. The system according to claim 16, wherein:
the audio data represents utterances of a child, the inferred condition data includes emotional state information and latent problem information of the child including at least one of a bullying risk indicator, an academic stress indicator, and a family conflict indicator, the operator terminal device is operated by at least one of a guardian and an educator, and the display control data is configured to present the risk-oriented score values to the guardian or the educator to support determination of support policy information for the child.

18. A system comprising:
circuitry configured to:
receive, via a communication interface coupled to a packet-switched network, utterance data or character data from a terminal device operated by a user;
convert, when the utterance data includes audio information, the audio information into the character data by executing speech recognition processing, and perform language processing on the character data to extract emotional state information and situational information, and generate emotion-related feature data from the emotional state information;
generate, on the basis of the emotion-related feature data, the emotional state information, and the situational information, a structured instruction sequence to be input to a generative neural network model comprising a transformer-based architecture, the structured instruction sequence embedding condition information specifying vocabulary constraints and expression constraints;
input the structured instruction sequence into the generative neural network model to cause the generative neural network model to generate a plurality of candidate output segments that satisfy the condition information;
present the plurality of candidate output segments to the user via the communication interface, acquire evaluation data from the user indicating an assessment of the candidate output segments, and update at least one of a construction process of subsequent structured instruction sequences and an estimation process of subsequent emotional state information based on the evaluation data; and
obtain, from a storage device in which supplementary data is stored in association with service identifier data or tool identifier data, supplementary data corresponding to attribute information or procedure information of the user, and incorporate the supplementary data into the structured instruction sequence.

19. The system according to claim 18, wherein the circuitry is further configured to:
extract, from the character data, expression patterns including comparison expressions, self-evaluation expressions, and other-evaluation expressions, specify the emotional state information as emotion category information including at least one of an inferiority category, an anxiety category, and a self-esteem category on the basis of the expression patterns, and embed the emotion category information together with at least one of living-environment information, relationship information, and personal-worry information into the structured instruction sequence.

20. A method performed by circuitry of a system, the method comprising:
receiving, via a communication interface coupled to a packet-switched network, audio data captured by a terminal device, and converting the audio data into character string data by executing speech recognition processing on the audio data using an acoustic model and a language model to generate a token sequence;
performing natural language processing on the character string data to extract emotion information including probability values over a plurality of emotion categories, intention information including communicative intent classification labels, and feature word information including semantically significant token identifiers;
constructing an instruction sequence based on the character string data, the emotion information, the intention information, and the feature word information, the instruction sequence having a structured layout comprising an utterance segment, a feature segment embedding the extracted information, and a directive segment specifying inference constraints;
inputting the instruction sequence into a generative neural network model comprising a transformer-based architecture with a plurality of self-attention layers to cause the generative neural network model to generate response data including inferred condition data and explanatory segment data;
storing the response data and the extracted information in a storage device in association with a subject identifier, and aggregating stored records associated with the subject identifier in a time-series arrangement to compute index data including a risk-oriented score value derived from a scoring function applied to accumulated emotion information and inferred condition data over a temporal window; and
generating display control data presenting a prioritized listing of subject identifiers arranged according to the risk-oriented score values, and transmitting the display control data to an operator terminal device via the communication interface.
